(19) United States
(12) Patent Application Publication
(10) Pub. No.: US 2025/0303822 A1
(43) Pub. Date: Oct. 2, 2025

(54) VEHICLE CLIMATE CONTROL SYSTEM UTILIZING A FLEXIBLE HEAT PUMP

(71) Applicant: HONEYWELL INTERNATIONAL INC., Charlotte, NC (US)

(72) Inventors: Sanmao BAI, Shanghai (CN); Curt VINCENT, Grand Rapids, MI (US); Michael PETERSEN, Buffalo, NY (US); Tao LIU, Shanghai (CN); Nilesh PUROHIT, Charlotte, NC (US)

(73) Assignee: HONEYWELL INTERNATIONAL INC., Charlotte, NC (US)

(21) Appl. No.: 19/074,287

(22) Filed: Mar. 7, 2025

Related U.S. Application Data
(60) Provisional application No. 63/563,252, filed on Mar. 8, 2024.
(60) Provisional application No. 63/635,746, filed on Apr. 18, 2024.
(60) Provisional application No. 63/635,747, filed on Apr. 18, 2024.
(60) Provisional application No. 63/665,190, filed on Jun. 27, 2024.
(60) Provisional application No. 63/666,460, filed on Jul. 1, 2024.
(60) Provisional application No. 63/666,464, filed on Jul. 1, 2024.

(51) Int. Cl. B60H 1/00; B60H 1/03; B60H 1/32

(52) U.S. Cl. CPC B60H 1/00914; B60H 1/034; B60H 1/32281

(57) ABSTRACT

A heat transfer system to alternatively and/or simultaneously provide heating and cooling in a mobile vehicle that includes an electrical power source requiring heating and/or cooling during charging and/or operation and that includes a cabin that requires heat input during low temperature ambient conditions.

### CROSS REFERENCE TO RELATED APPLICATIONS

The present invention is related to and claims the priority benefit of U.S. Provisional Application No. 63/563,252, filed Mar. 8, 2024 and of U.S. Provisional Application No. 63/635,746, filed Apr. 18, 2024 and of U.S. Provisional Application No. 63/635,747, filed Apr. 18, 2024 and of U.S. Provisional Application No. 63/665,190, filed Jun. 27, 2024 and of U.S. Provisional Application No. 63/666,460, filed Jul. 1, 2024 and of U.S. Provisional Application No. 63/666,464, filed Jul. 1, 2024, each of which is incorporated herein by reference in their entirety.

### FIELD

The present invention relates to thermal management systems for electric vehicles and in particular to a flexible and efficient climate control system arrangement and method utilizing a heat pump for such vehicles.

### BACKGROUND

A vehicle, such as a car or truck, which is propelled solely by one or more electric motors, sometimes referred to as a traction motor, is typically referred to as an electric vehicle or an EV. In a hybrid electric vehicle, or HEV, one or more traction motors are used in conjunction with another power source, such as for example an internal combustion engine, including both gasoline and diesel-powered engines. In both cases, a battery and/or capacitor bank carried by the vehicle during operation provides an electrical current to the traction motor and other components that are driven by an electric current and which will generally generate heat during operations.

Because the propulsion systems of EVs do not include an internal combustion engine, a traditional internal combustion engine cooling system is not present, and therefore hot liquid coolant is unavailable for heating the interior of the cabin, cab, or passenger compartment of the vehicle. Although an internal combustion engine is included in HEVs, there are times when it may be desirable to operate the HEV without running the internal combustion engine, in which case heat may be unavailable from circulating hot liquid coolant to heating the interior of the cabin, cab, or passenger compartment. Furthermore, it is frequently required that, in addition to the need to heat the cabin, cab, or passenger compartment for the comfort of the occupants, heat is frequently also required to defrost the vehicle windows.

The development of a thermal management system to handle the heating and cooling needs of EVs is challenging for several reasons. For example, it has been known to provide another source of heat, such as electric heaters, in EVs to provide at least some of the heat needed by the vehicle as described above. Such electric heaters, however, typically draw electric current from the same on-board source of electricity that supplies current to the traction motor that is used to propel the vehicle. It can be a disadvantage to require the use of such a heating source since it can limit the range of the EV or limit the number of miles in which an HEV is propelled by the traction motor.

Another challenge associated with the development of EVs and HEVs thermal management system is that such systems also require the ability to cool the cabin, cab, or passenger compartment during warmer weather. In conventional non-electric vehicles, such air conditioning is provided by a compressor that is mechanically driven by the internal combustion engine. Because an EV lacks an internal combustion engine, and because the internal combustion engine of a hybrid electric vehicle may be turned off for periods of time, it is desirable to provide an alternate source of cooling for the cab, cabin, or passenger compartment for such vehicles when air conditioning is desired.

Another challenge involves the potential need to manage the temperature of the battery and/or other electrical components of EVs, and potentially for some HEVs, including when the vehicle is stationary, and the battery is being charged by an external source of electrical current, such as would occur at a charging station.

Therefore, heating and cooling of the cab, cabin, or passenger compartment of an EV or an HEV, including defrosting of the vehicle windows, is a challenging task that should provide effective and efficient thermal operation while having the lowest possible impact on the range of the vehicle or on environmental performance of the EV or HEV. The operation of a system to provide this heat and/or cooling is even more challenging for those applications in which it is necessary or desirable to provide heating and/or cooling to the battery and/or other electronic components.

### SUMMARY

The present invention provides heat transfer systems to alternatively and/or simultaneously provide heating and cooling in a mobile vehicle that includes an electrical power source requiring temperature regulation during operation and that includes a cabin that requires heat input during low temperature ambient conditions, said system comprising:
a) a vapor compression refrigeration circuit located in said mobile vehicle comprising:
   (i) a heat transfer composition comprising a first refrigerant,
   (ii) a compressor for compressing said first refrigerant in the vapor state from a first pressure to a higher second pressure, said compressor, optionally but preferably, being connected upstream to a refrigerant accumulator,
   (iii) an inner condenser for selectively condensing during low temperature ambient conditions at least a portion of said first refrigerant vapor from said compressor by rejecting heat to said cabin,
   (iv) an outside heat exchanger located downstream of said inner condenser to selectively either (1) condense during low temperature ambient conditions at least a portion of said higher pressure refrigerant vapor not condensed in said inner condenser by rejecting heat, directly or indirectly, to ambient air and/or to a circulating coolant or (2) evaporate during high temperature ambient conditions low pressure refrigerant liquid from said inner condenser vapor;
(v) a first OCE (as defined hereinafter) connected between said inner condenser and said outside heat exchanger for selectively (1) providing in an expansion mode a flow of reduced pressure liquid refrigerant from said inner condenser to said outside heat exchanger; (2) allowing in an open mode said condensed high pressure refrigerant from said condenser to pass to said outside condenser without pressure drop to said outside heat exchanger; or (3) preventing in a closed mode the flow of refrigerant from said inner condenser to said outside heat exchanger;
(vi) an inside heat exchanger fluidly connectable to said refrigerant downstream of said inner condenser for selectively heating a flow of cabin air;
(vii) a chiller fluidly connectable to said refrigerant downstream of said inner condenser for selectively heating a flow of liquid coolant;
(viii) a bypass channel system connected upstream of said first open/closed/expansion device and downstream of said outside heat exchanger for selectively routing said refrigerant from said inner condenser and/or from said outside heat exchanger: (1) around said first expansion device and to either (A) a second OCE device fluidly connected to said inside heat exchanger for selectively (a) providing in an expansion mode a flow of reduced pressure liquid refrigerant from said inner condenser to said inside heat exchanger; (b) allowing in an open mode said condensed high pressure refrigerant from said condenser or from said outside heat exchanger to pass without pressure reduction to said inside heat exchanger; or (c) preventing in a closed mode the flow of refrigerant to said inside heat exchanger; and/or (B) an expansion device fluidly connected to said chiller for selectively (a) providing in an expansion mode a flow of reduced pressure liquid refrigerant to said chiller; or (b) preventing in a closed mode the flow of refrigerant to said chiller; or (2) through said first OCE device operating in the expansion mode through said outside heat exchanger to said accumulator;
b) a heat exchange network interconnected with said vapor compression refrigeration circuit to selectively; (i) deliver, directly or indirectly, at said outside heat exchanger and/or at said chiller evaporative heat from one or more of ambient air and/or heat associated with the generation or use of electrical power within the vehicle and/or at said inside heat exchanger either directly or indirectly from (1) ambient air and/or (2) said electrical power source located in said vehicle.
   For the purposes of convenience, the heat transfer system as described in this paragraph is referred to for convenience as Heat Transfer System 1A.

The present invention also provides heat transfer systems as described herein, including Heat Transfer System 1, in which the refrigerant used in the vapor compression refrigeration circuit comprises, or consists essentially of, or consists of, on a weight basis, HFO-1234yf. For the purposes of convenience, the heat transfer system as described in this paragraph is referred to for convenience as Heat Transfer System 1B.

The present invention also provides heat transfer systems as described herein, including Heat Transfer System 1, in which the refrigerant used in the vapor compression refrigeration circuit comprises, or consists essentially of, or consists of, on a weight basis, HFO-1234ze(E). For the purposes of convenience, the heat transfer system as described in this paragraph is referred to for convenience as Heat Transfer System 1C.

The present invention also provides heat transfer systems as described herein, including Heat Transfer System 1, in which the refrigerant used in the vapor compression refrigeration circuit comprises, or consists essentially of, or consists of, on a weight basis, about 21.5% of R32, about 28% by weight of R1132(E) and about 51.5% of R1234yf. For the purposes of convenience, the heat transfer system as described in this paragraph is referred to for convenience as Heat Transfer System 2A.

The present invention also provides a heat transfer system as described above including Heat Transfer System 1, in which the heat exchange network comprises a coolant circuit that comprises a coolant that absorbs waste heat from an electrical power source located in said vehicle during low temperature ambient conditions and rejects heat to said refrigerant in said chiller. As used herein, reference to “Heat Transfer System 1” is a reference to each of Heat Transfer System 1A and Heat Transfer System 1B and Heat Transfer System 1C. The systems of the present invention, including each of Heat Transfer System 1A, 1B and 1C, are particularly well adapted to operate with system pressures that are similar to the pressures that have been present in vapor compression systems that use the refrigerants R410A, but without the substantial environmental disadvantages associated with the use of those refrigerants.

As used herein, the term “waste heat from an electrical power source” refers to heat that needs to be and/or can removed from an on-board battery or an electrically powered device or article powered by the on-board battery or an off-board source of electrical power, such as the charging source that is being used to charge the batter. By way of example, such devices include the vehicle battery, motor, inverter and other electrical devices carried by the vehicle.

### BRIEF DESCRIPTION OF THE DRAWINGS

FIG. 1 illustrates a schematic of a thermal management system for an EV or HEV according to one example of the present invention.

FIGS. 2A and 2B illustrate a schematic of a thermal management system for an EV or HEV according to a second example of the present invention.

FIG. 3A illustrates a respective schematic of an exemplary thermal management system, generally as illustrated in FIG. 2.

FIG. 3B illustrates a preferred generalized alternative modes of operation of the respective schematic generally illustrated in FIG. 3A.

FIG. 3C illustrates a preferred generalized alternative mode of operation of the respective schematic generally illustrated in FIG. 3A.

FIG. 3D illustrates a preferred generalized alternative mode of operation of the respective schematic generally illustrated in FIG. 2.

FIG. 3D1 illustrates a preferred generalized alternative mode of operation of the respective schematic generally illustrated in FIG. 2.

FIG. 3D2-1 illustrates a preferred generalized alternative mode of operation of the respective schematic generally illustrated in FIG. 2.

FIG. 3D2-2 illustrates a preferred generalized alternative mode of operation of the respective schematic generally illustrated in FIG. 2.

FIG. 3D2-3 illustrates a preferred generalized alternative mode of operation of the respective schematic generally illustrated in FIG. 2.

FIG. 3D3-1 illustrates a preferred generalized alternative mode of operation of the respective schematic generally illustrated in FIG. 2.

FIG. 3D3-2 illustrates a preferred generalized alternative mode of operation of the respective schematic generally illustrated in FIG. 2.

FIG. 3E illustrates the COP and Capacity data from Example 1A.

FIG. 3F illustrates a preferred generalized alternative mode of operation of the respective schematic generally illustrated in FIG. 2.

FIG. 3G illustrates a preferred generalized alternative modes of operation of the respective schematic generally illustrated in FIG. 2.

FIG. 4 illustrates a schematic of the thermal management system, generally as illustrated in FIG. 2 and FIGS. 3A-3D, for the operating mode as described in Example 2 hereof.

FIG. 5 illustrates a schematic of the thermal management system, generally as illustrated in FIG. 2 and FIGS. 3A-3D, for the operating mode as described in Example 3 hereof.

FIG. 6 illustrates a schematic of the thermal management system, generally as illustrated in FIG. 2 and FIGS. 3A-3D, for the operating mode as described in Example 4 hereof.

FIG. 7 illustrates a schematic of the thermal management system, generally as illustrated in FIG. 2 and FIGS. 3A-3D, for the operating mode as described in Example 5 hereof.

FIG. 8 illustrates a schematic of the thermal management system, generally as illustrated in FIG. 2 and FIGS. 3A-3D, for the operating mode as described in Example 6A hereof.

FIG. 9 illustrates a schematic of the thermal management system, generally as illustrated in FIG. 2 and FIGS. 3A-3D, for the operating mode as described in Example 7A hereof.

FIG. 10 illustrates a schematic of the thermal management system, generally as illustrated in FIG. 2 and FIGS. 3A-3D, for the operating mode as described in Example 8 hereof.

FIG. 11 illustrates a schematic of the thermal management system, generally as illustrated in FIG. 2 and FIGS. 3A-3D, for the operating mode as described in Example 9 hereof.

FIG. 12 illustrates a schematic of the thermal management system, generally as illustrated in FIG. 2 and FIGS. 3A-3D, for the operating mode as described in Example 10 hereof.

FIG. 13 illustrates a schematic of the thermal management system, generally as illustrated in FIG. 2 and FIGS. 3A-3D, for the operating mode as described in Example 11 hereof.

FIG. 14 illustrates a schematic of the thermal management system, generally as illustrated in FIG. 2 and FIGS. 3A-3D, for the operating mode as described in Example 12 hereof.

FIG. 15 illustrates a schematic of the thermal management system, generally as illustrated in FIG. 2 and FIGS. 3A-3D, for the operating mode as described in Example 13 hereof.

FIG. 16 illustrates a schematic of the thermal management system, generally as illustrated in FIG. 2 and FIGS. 3A-3D, for the operating mode as described in Example 14 hereof.

FIG. 17 illustrates a schematic of the thermal management system, generally as illustrated in FIG. 2 and FIGS. 3A-3D, for the operating mode as described in Example 15 hereof.

FIG. 18 illustrates a schematic of the thermal management system, generally as illustrated in FIG. 2 and FIGS. 3A-3D, for the operating mode as described in Example 16 hereof.

FIG. 19 illustrates a schematic of the thermal management system, generally as illustrated in FIG. 2 and FIGS. 3A-3D, for the operating mode as described in Example 17 hereof.

FIG. 20 illustrates a schematic of the thermal management system, generally as illustrated in FIG. 2 and FIGS. 3A-3D, for the operating mode as described in Example 18 hereof.

FIG. 21A illustrates a schematic of the thermal management system, generally as illustrated in FIG. 2 and FIGS. 3A-3D, for the operating mode as described in Example 19A hereof.

FIG. 21B illustrates a schematic of the thermal management system, generally as illustrated in FIG. 2 and FIGS. 3A-3D, for the operating mode as described in Example 19B hereof.

FIG. 22 illustrates a schematic of the thermal management system, generally as illustrated in FIG. 2 and FIGS. 3A-3D, for the operating mode as described in Example 20 hereof.

FIG. 23 illustrates a schematic of the thermal management system, generally as illustrated in FIG. 2 and FIGS. 3A-3D, for the operating mode as described in Example 21 hereof.

FIG. 24 illustrates a schematic of the thermal management system, generally as illustrated in FIG. 2 and FIGS. 3A-3D, for the operating mode as described in Example 22 hereof.

FIG. 25 illustrates a schematic of the thermal management system, generally as illustrated in FIG. 2 and FIGS. 3A-3D, for the operating mode as described in Example 23 hereof.

FIG. 26 illustrates a schematic of the thermal management system, generally as illustrated in FIG. 2 and FIGS. 3A-3D, for the operating mode as described in Example 24 hereof.

FIG. 27 illustrates a schematic of the thermal management system, generally as illustrated in FIG. 2 and FIGS. 3A-3D, for the operating mode as described in Example 25 hereof.

FIG. 28 illustrates a schematic of the thermal management system, generally as illustrated in FIG. 2 and FIGS. 3A-3D, for the operating mode as described in Example 26 hereof.

FIG. 29A illustrates a schematic of the thermal management system, generally as illustrated in FIG. 2 and FIGS. 3A-3D, for the operating mode as described in Example 27 hereof.

FIG. 29B provides the COP and capacity data of the system of Example 27 hereof.

FIG. 30 illustrates a schematic of the thermal management system, generally as illustrated in FIG. 2 and FIGS. 3A-3D, for the operating mode as described in Example 28 hereof.

FIG. 31 illustrates a schematic of the thermal management system, generally as illustrated in FIG. 2 and FIGS. 3A-3D, for the operating mode as described in Example 30A hereof.

FIG. 31A provides the operating data for an operating mode of the system of Example 30A.

FIG. 31B provides the operating data for an operating mode of the system of Example 30A.

FIG. 31C illustrates a schematic of the thermal management system, generally as illustrated in FIG. 2 and FIGS. 3A-3D, for the operating mode as described in Example 30A hereof, but with the alternative configuration comprising the use of hot radiator air at the OHE and/or the IHE and/r the inner condenser.

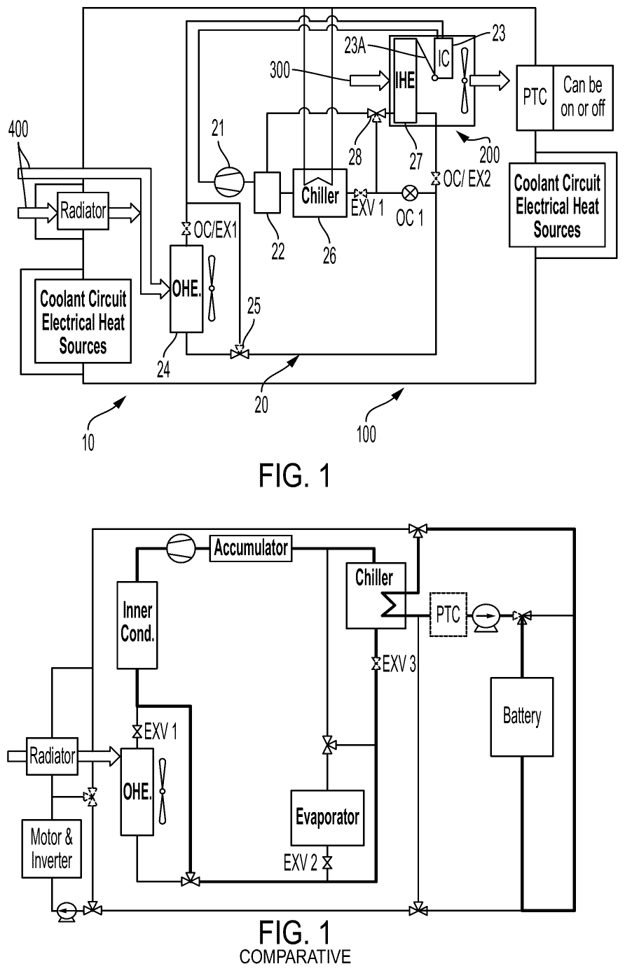

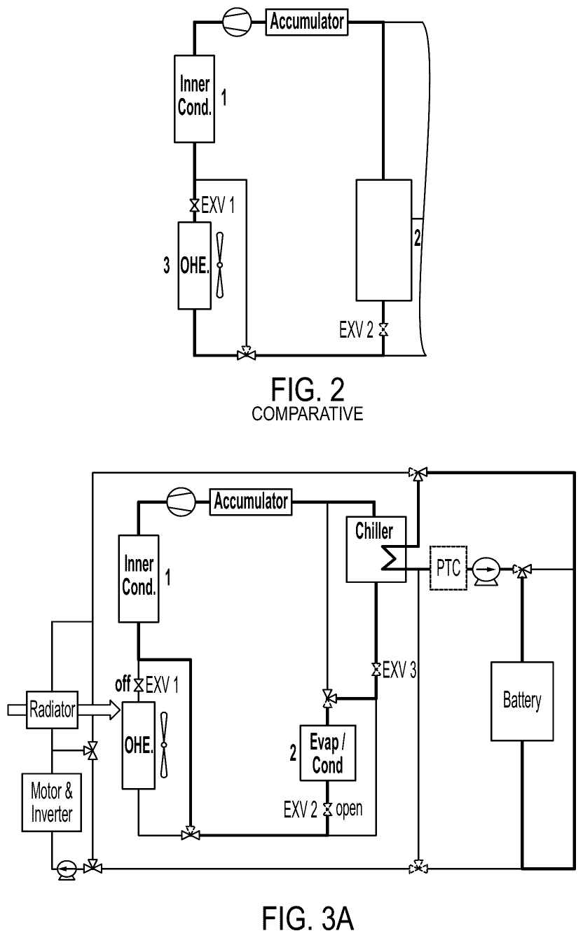

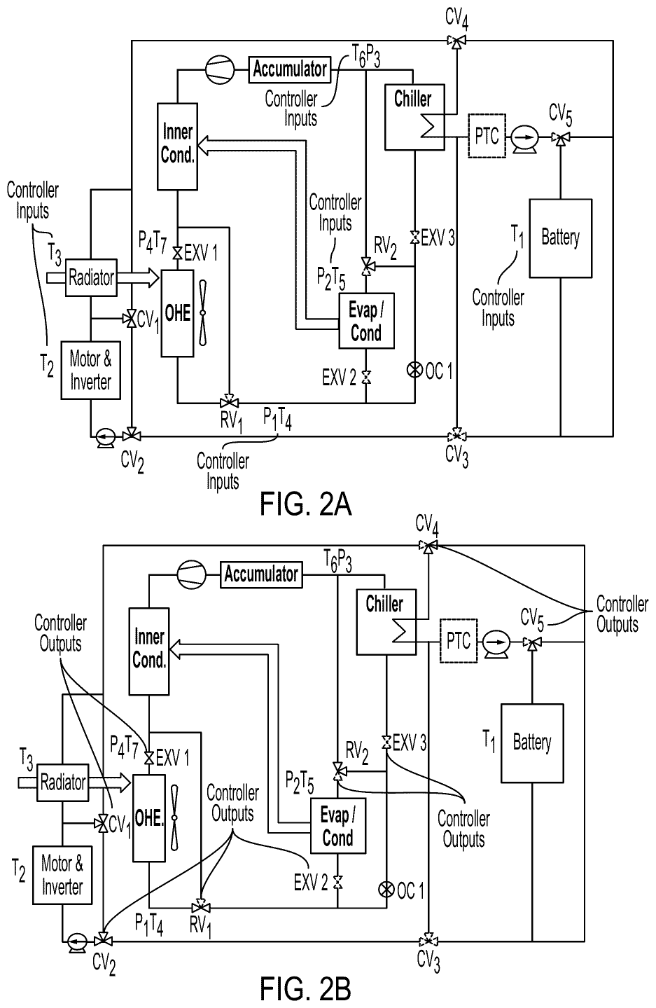

Comparative FIG. 1 and Comparative FIG. 2 illustrate schematics of comparative thermal management systems according to Comparative Example 1 and Comparative Example 2.

### Definitions

The phrase “coefficient of performance” (herein abbreviated as “COP”) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration, cooling or heating capacity to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. One means for estimating COP of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988 which is incorporated herein by reference in its entirety).

The phrase “Global Warming Potential” (herein abbreviated as “GWP”) was developed to allow comparisons of the global warming impact of different gases. It compares the amount of heat trapped by a certain mass of a gas to the amount of heat trapped by a similar mass of carbon dioxide over a specific time period of time. Carbon dioxide was chosen by the Intergovernmental Panel on Climate Change (IPCC) as the reference gas and its GWP is taken as 1. The larger GWP, the more that a given gas warms the Earth compared to CO2 over that time period. As used herein, the term GWP means the value of GWP as measured in accordance with IPCC Fourth Assessment Report, 20141, referred to and abbreviated herein as AR4, except for components that did not have a GWP value measured in AR4 (such as R1234yf), then the values used are according to the Fifth Assessment Report.

As used herein, the terms “positive temperature coefficient heater,” “PTC heater” and “PTC” mean a heating device that provides heat via electrical current input, including preferably a heating device that comprises a ceramic heating element with a positive temperature coefficient.

As used herein, the term OCE refers to a device, such as a valve, that can operate in the open position, the closed position and in an expansion mode in which it operates, for example, as an expansion orifice or valve.

As used herein, the terms 1234yf and R1234yf means 2,3,3,3-tetrafluoropropene.

As used herein, the terms 1234ze (E) and R1234ze (E) mean the trans isomer of 1,3,3,3-tetrafluoropropene.

As used herein, the terms “R-32” and “HFC-32” as used herein each mean difluoromethane.

As used herein, the terms “R1132(E)” and “transHFO-1132(E)” each means the trans isomer of 1,2-difluorethylene.

As used herein, the term “R479A” means the refrigerant designated by ASHRAE as 479A and which consists of 21.5%+2/−2% of R-32, 28%+2/−2% of R-1132(E) and 50.5+2/−2% of HFC-1234yf. ¹ Myhre, G., D. Shindell, F.-M. Bréon, W. Collins, J. Fuglestvedt, J. Huang, D. Koch, J.-F. Lamarque, D. Lee, B. Mendoza, T. Nakajima, A. Robock, G. Stephens, T. Takemura and H. Zhang, 2013: Anthropogenic and Natural Radiative Forcing. In: Climate Change 2013: The Physical Science Basis. Contribution of Working Group I to the Fifth Assessment Report of the Intergovernmental Panel on Climate Change [Stocker, T. F., D. Qin, G.-K. Plattner, M. Tignor, S. K. Allen, J. Boschung, A. Nauels, Y. Xia, V. Bex and P. M. Midgley (eds.)]. Cambridge University Press, Cambridge, United Kingdom and New York, NY, USA. https://www.ipcc.ch/pdf/assessmentreport/ar5/wg1/WG1AR5_Chapter08_FINAL.pdf (p. 73-79)

### DETAILED DESCRIPTION

An exemplary thermal management system according to the present invention is illustrated in FIG. 1 hereof. The thermal management system, including the components of the EV or HEV being heated or cooled, are designated generally as 10, and includes an area in which one or more persons would travel, which is referred to generally herein as the “cabin” (not shown) and areas outside the cabin which will generally house the working components of the EV or HEV. Portions of the various thermal management systems of the present invention may be located within the cabin and/or outside the cabin.

The system 10 of the present invention includes heat pump subsystem, which preferably comprises may be a vapor compression system designated generally as 20 thermally interconnected with a coolant circuit, designated generally as 100, a cabin climate control module 200 and potentially also independently fluidly connected with a source of ambient air, designated as 300. It will be understood that since some of the components of the vapor compression circuit interface with some components of the coolant circuit and the climate control module 200, those portions may be properly designated as components of each of those portions of the system.

In particular, the vapor compression system includes a refrigerant, preferably R-R-1234ze (E), R-1234yf or blends that comprise R-1234yf, or 1234ze (E) or blends that comprise R-1234ze (E), that circulates to various components of the present invention, a compressor 21, optionally but preferably an accumulator 22 on the suction side of the compressor and inner condenser 23 located in the climate control module 200. Although it is contemplated that the specific heat exchanger used to for the inner condenser can vary widely according to the particular needs of a particular application, in some embodiments, particularly in which the heating mode of the system is especially important, it is preferred that a four-pass or higher configuration is used, since applicants have found that such a configuration can provide unexpected levels of improvement in COP performance and capacity performance in the heating mode, as well as possible lower compressor discharge temperatures and pressures. The climate control module 200 preferably includes a door 23A on the inner condenser 23 which can be moved to any position between a fully closed position (as shown) in which no cabin air which enters the control module can flow through the inner condenser to a fully open position in which the door permits air from the cabin to flow fully through the inner condenser and to be heated as it condenses at least a portion of the refrigerant which flows into the condenser from the discharge side of the compressor.

Refrigerant which exits the inner condenser is fluidly connected to an OCE device (labeled as OC/EX1). The preferred OC/EX1 is a device that can be configured to take one of three possible actions: (1) change the pressure and temperature of the refrigerant flowing therethrough; (2) open fully so as to allow passage of refrigerant therethrough with minimal change in pressure or temperature; or (3) close so as to prevent the flow of refrigerant therethrough. The OCE devices that are used in the present invention may include an electronic actuator-controlled controller (see FIGS. 2A and 2B), which may cause the actuator to position the expansion device in the wide-open position, in the fully closed position, or a throttled position in which flow is permitted but at a substantially reduced pressure and temperature. The throttled position typically is a partially open position where the controller modulates the size of the valve opening to regulate flow through the device. The controller and OCE devices may be configured to continuously or periodically modulate the throttled position in response to system operating conditions. By throttling the position of the expansion device, the controller can regulate flow, pressure, temperature, and state of the refrigerant as needed.

By operating the OC/EX1 in the fully opened position, the outside heat exchanger 24 (which is located outside the passenger cabin) can be used during low temperature ambient conditions in a supplemental condensation mode to condense at least a portion of any refrigerant vapor that is not condensed in the inner condenser 23 by rejecting heat to the relatively low temperature ambient air 400 directly, or preferably indirectly after ambient air has passed through the radiator of the circulating coolant system. During periods of high temperature ambient conditions, for example, the OC/EX1 can be operated in the throttled position and the outside heat exchanger can operate as an evaporator or alternatively the outside condenser can be bypassed by operating the OCEX1 in the fully closed position, which will direct the refrigerant flow from the inner condenser through the bypass conduit and to the divert valve 25.

The refrigerant which flows through diverter valve 25 can be directed to chiller 26 and/or inner heat exchanger 27 or to bypass each of these and flow through diverter valve 28 directly to accumulator 22. An open/closed valve OC 1 may be provided downstream of diverter valve 25 and upstream of EXV1, and in the closed position blocks flow towards EXV1, thereby ensuring that refrigerant flows to OC/EX2. As an alternative in some cases, EXV1 may be provided as an OC/EV and operated in a closed position to prevent flow of refrigerant to the chiller, as illustrated in some of the examples below. A second OCE (labeled as OC/EX2) is provided upstream of the inner heat exchanger and can be operated to allow refrigerant to flow to the inner heat exchanger either in the fully open position (i.e., without substantial pressure reduction) or in the throttling mode. The OC/EX2 can also be operated in the fully closed position to prevent the flow of refrigerant to the inner heat exchanger 27.

As illustrated particularly in the following examples, the many advantages of the systems of the present include, but are not necessarily limited to:
1—eliminate or reduce condensing capacity issues in cold weather;
2—eliminate or reduce icing issues at the outside heat exchanger;
3—eliminate or reduce the need for high voltage PTC (positive temperature coefficient) heaters inside the vehicle;
4—offset heating capacity reduction in cold weather
5—battery warming with PTC, if present, in very cold weather
6—using the inside heat exchanger either as an evaporator or a condenser extension and pre warmer
7—extending the heat pump initial air temperature range for R-1234yf;
8—using the outside heat exchanger (radiator) to reject heat from components instead of the chiller
9—warming the motor and inverter for higher efficiency before cold starts;
10—using the inside condenser for dehumidification reheat, which is more efficient than using PTC;
11—ability to use all sources for the heat pump (in any combination) at the OHE or chiller;
12—ability to cool all heat sources at the Radiator
13—ability to cool all heat sources at the Chiller
14—ability to self-heat motor and inverter and battery independently.
15—ability to self-heat motor and inverter and battery in series; and
16—ability to cool the motor and inverter (at outside heat exchanger (radiator)) and battery (at chiller) concurrently

The present invention also provides a heat transfer systems as described herein, including in the Examples below and including each of Heat Transfer System 1A, Heat Transfer System 1B, Heat Transfer System 1C and Heat Transfer System 2A, in which the heat transfer composition further comprises a lubricant.

The present invention also provides a heat transfer systems as described herein, including in the Examples below and including each of Heat Transfer System 1A, Heat Transfer System 1B and Heat Transfer System 1C, in which the heat transfer composition further comprises a polyol ester POE lubricant.

The present invention also provides a heat transfer systems as described herein, including in the Examples below and including each of Heat Transfer Systems 1-2, in which the heat transfer composition further comprises a poly vinyl ether (“PVE”) lubricant.

### EXAMPLES

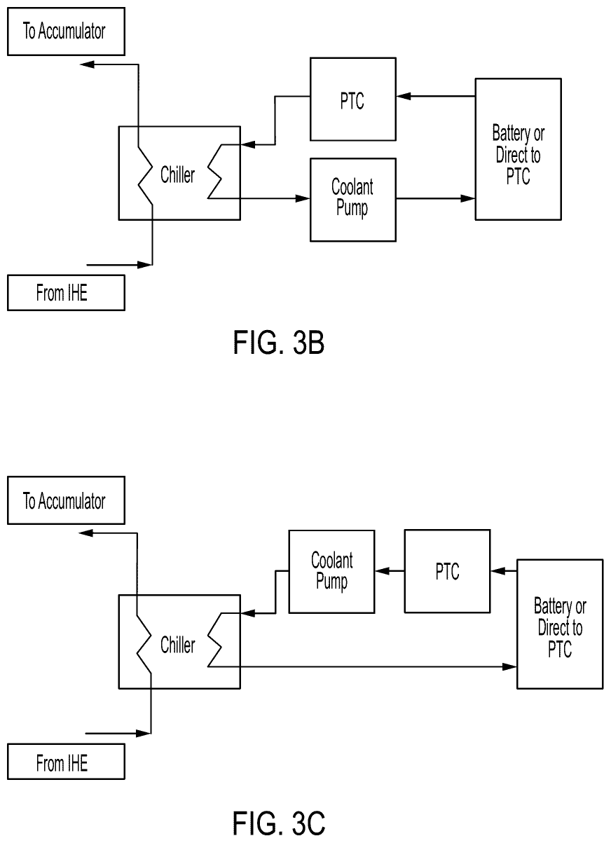

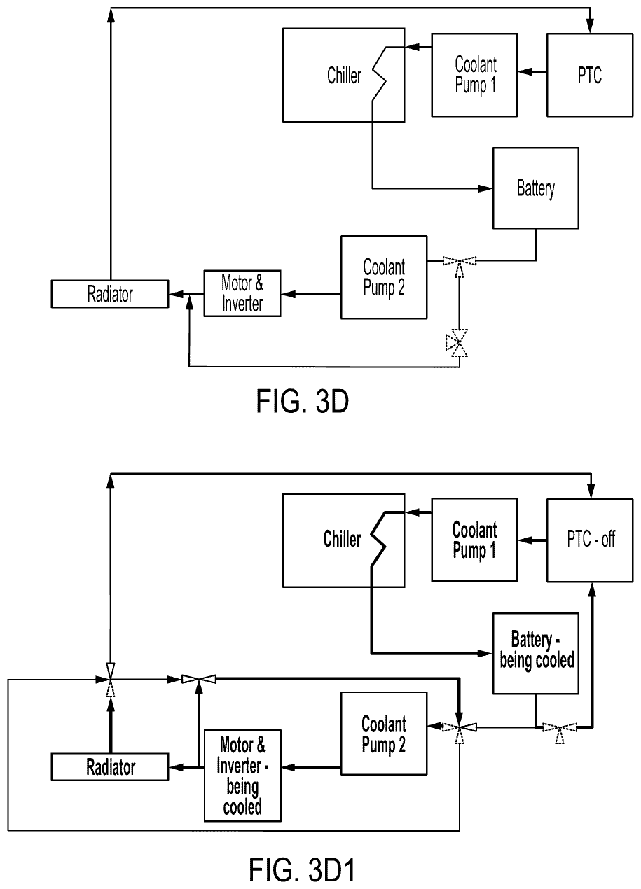

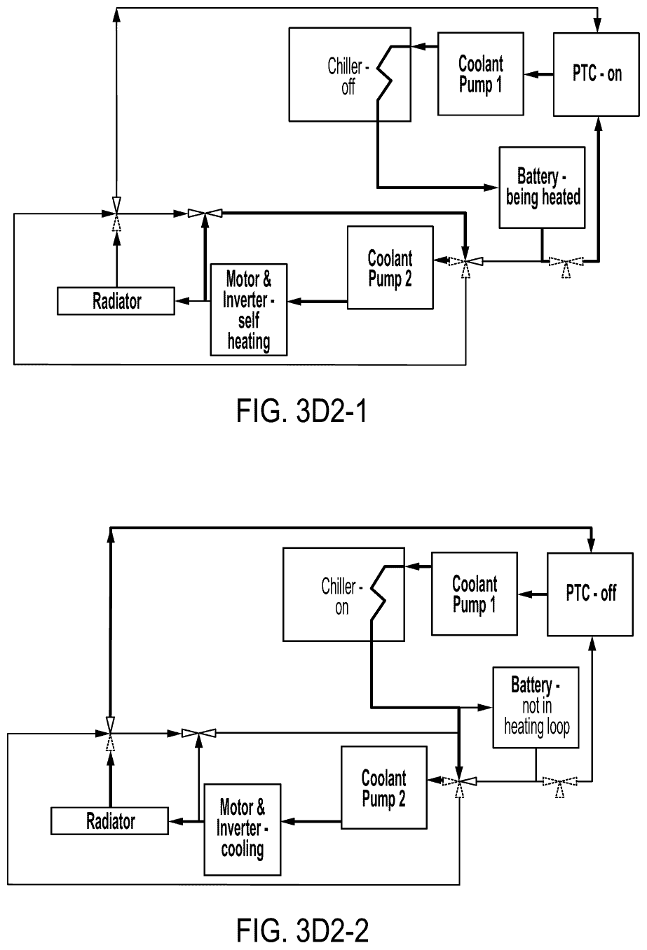

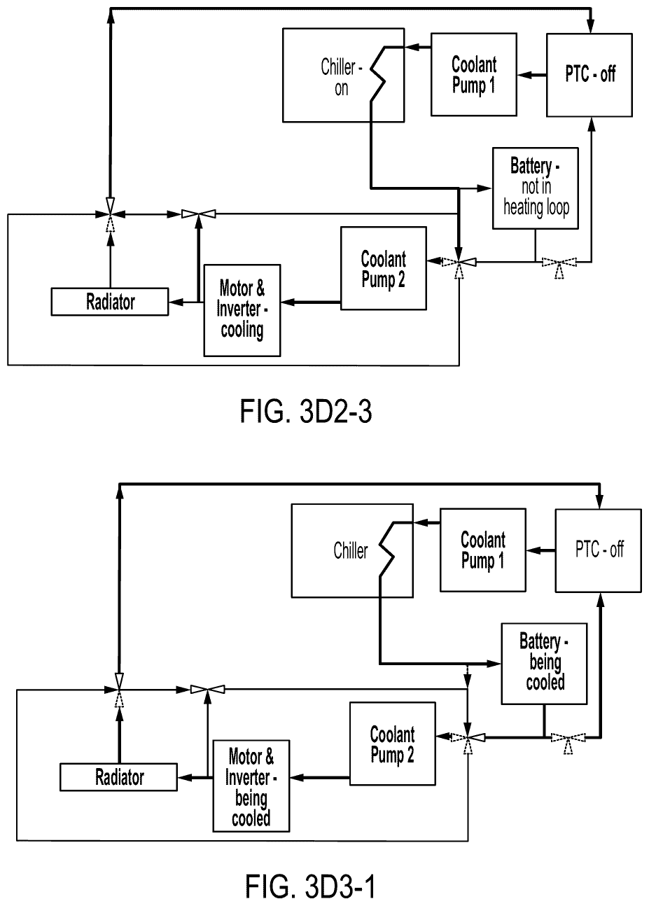

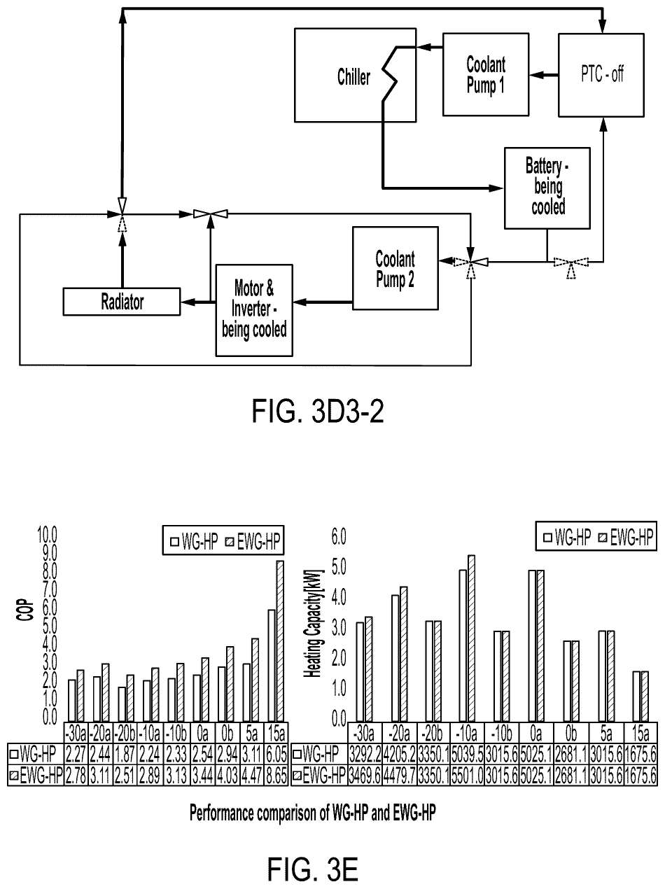

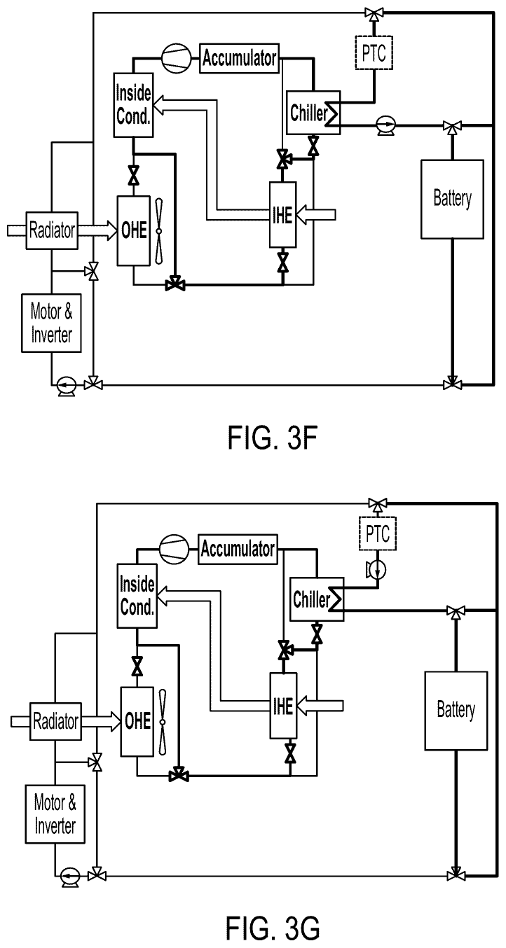

The following examples use a thermal management system according to embodiments of the invention as illustrated in FIGS. 2A-2B and 3A-3D. The present invention, including embodiments as illustrated in FIGS. 2A and 2B and as referenced in the following examples, is able to provide at least the following advantageous features:
A) the ability to use at least the following four sources of evaporative energy for heating, via heat pump or otherwise, of an electric vehicle cabin and/or its components:
   1. Waste (or excess) energy from the motor and inverter
   2. Waste (or excess) energy from the battery
   3. Electrical energy from a heater (PTC)
   4. Free energy from the environment (air)
B) two locations within the system where energy can be absorbed (as the evaporative heat source) and used by the heat pump to warm the vehicle and/or its components:
   1. The outside heat Exchanger (with airflow)
   2. The chiller (with coolant flow)

### Comparative Example 1—Heat Pump Mode to Warm Cabin Air

The operation of a typical prior heat pump system for use in an EV is illustrated in Figure C1 using the thick solid lines to illustrate the only options available in prior art operation, and the results of the use in this configuration is used as the basis for results of the comparative data reported for this Comparative Example 1 (referred to as “CE1 data”). In this system battery waste heat is carried by a coolant (such as water/glycol for example) away from the battery and the PTC and is used as the evaporative heat source at the chiller of a vapor compression system, as shown in Figure C1. This configuration may be effective in certain cases, but applicants have come to appreciate that in many circumstances and/or desired modes of operation, including at relatively low ambient temperature conditions, full condensing is frequently not achieved at the inner condenser 1, which detracts from the capacity and effectiveness of such systems in such situations. This Comparative Example 1 and the embodiment of the present invention described in connection with Example 1A which follows, is based upon the use of R-1234yf as the refrigerant.

### Example 1A—Heat Pump Mode with Inner Evaporator/Condenser in the Loop to Warm Cabin Air

Applicants have come to appreciate that when ambient temperatures are relatively low, EVs as previously configured, including as described in Comparative Example 1 and illustrated by the thick solid lines in Comparative FIG. 1, can have a problem with insufficient condenser surface area at the inner condenser 1 to provide complete condensation, which can result in problems with system capacity and efficiency (COP). Applicants have found that systems of the present invention as described and illustrated herein can dramatically improve performance with relatively simple and low-cost modifications that provide not only unexpectedly superior performance but also high levels of operability over a wide variety of ambient conditions and of modes of cooling and heating to be carried out by the system. The system of the present invention in accordance with this Example 1A is configured for operation to heat cabin air during periods of low ambient temperatures and is illustrated in FIG. 3A.

In this system, and in the remaining systems illustrated in the Examples, the label

“Inner Cond” designates the same heat exchanger referenced in FIG. 1 as the internal condenser 23 or “IC” 23 and the heat exchanger designated as Evap/Cond designates the same heat exchanger designated as “internal heat exchanger” or “IHE” 27, as described and shown in FIG. 1 located in essentially the same relative positions and arrangement, including with presence of a door and cabin air as illustrated and explained in connection with FIG. 1. In addition, each of the Figures according to the present invention will have as needed an open/close valve to prevent the flow of refrigerant to the EXV leading to the chiller, even though such valve is not always illustrated in these figures for convenience. It will be understood that these relative positions and features are present but not always illustrated strictly for the purposes of convenience in this figure and the remaining figures to facilitate easier illustration of the system.

As illustrated in FIG. 3A, the present system allows the ability to selectively alter the flow of refrigerant form the inner condenser 1 to the inner heat exchanger 2 through an open OC/EX, that is, entering the heat exchanger 2 at the same pressure and temperature at the exit of the inner condenser. In this way, the inner heat exchanger 2 provides additional condensing surface and at the same time serves as a preheater (with door fully open, thereby allowing the preheated cabin air to enter the inner condenser) for the cabin air entering the inner condenser.

The conditions tested and the relative capacity and effectiveness of the two systems operating in this manner are reported in the Tables 1 and 2 and illustrated for convenience as FIG. 3E, with the results from this Example 1A (using 1234yf as the refrigerant) reported as EWG-HP and the results from Comparative Example 1 (using 1234yf as the refrigerant) reported as WG-HP.

TABLE 1
Example operating conditions

| | Outdoor conditions | Indoor conditions | | | Water-Glycol Condition | |
|---|---|---|---|---|---|---|
| | Ambient/Temp Air | Temp Air | Air Flow | Target Temp at | Temp WG In | Flow |
| Test | In | In | Rate | Outlet | Tamb + 5° C. | Rate |
| Name | [° C.] | [° C.] | [kg/min] | [° C.] | [° C.] | [L/min] |
| −30a | −30 | −30 | 4 | 50/Max | −25 | 8 |
| −20a | −20 | −20 | 6 | 50 | −15 | 8 |
| −20b | | 0 | 4 | | | |
| −10a | −10 | −10 | 6 | 50 | −5 | 8 |
| −10b | −10 | 5 | 4 | 50 | −5 | 8 |
| 0a | 0 | 0 | 6 | 50 | 5 | 8 |
| 0b | | 10 | 4 | | | |
| 5a | 5 | 5 | 4 | 50 | 10 | 8 |
| 15a | 15 | 15 | 4 | 40 | 20 | 8 |

TABLE 2
Temperature and pressure data

| | WG-HP (configuration as per solid thick lines in | | | | | | | | EWG-HP (configuration as per thick solid lines in | | | | | | | |
|---|---|---|---|---|---|---|---|---|---|---|---|---|---|---|---|---|
| | Comparative FIG. 1) | | | | | | | | FIG. 3A) | | | | | | | |
| | Condition | | | | | | | | | | | | | | | |
| | T4 | T5 | T6 | T7 | p1 | p2 | p3 | p4 | T4 | T5 | T6 | T7 | p1 | p2 | p3 | p4 |
| Units | ° C. | ° C. | ° C. | ° C. | bar | bar | bar | bar | ° C. | ° C. | ° C. | ° C. | bar | bar | bar | bar |
| −30a | 27.52 | NA | −34.47 | 27.52 | 9.56 | NA | 0.81 | 9.56 | 18.00 | 5.34 | −35.89 | 18.00 | 5.34 | 18 | 5.34 | 5.34 |
| −20a | 36.2 | NA | −25.88 | 36.2 | 11.88 | NA | 1.18 | 11.88 | 23.49 | 6.54 | −27.82 | 23.49 | 6.54 | 23.49 | 6.54 | 6.54 |
| −20b | 60.59 | NA | −23.07 | 60.59 | 20.71 | NA | 1.33 | 20.71 | 48.35 | 12.52 | −24.87 | 48.35 | 12.52 | 48.35 | 12.52 | 12.52 |
| −10a | 55.27 | NA | −15.76 | 55.27 | 18.84 | NA | 1.78 | 18.84 | 44.99 | 11.53 | −18.22 | 44.99 | 11.53 | 44.99 | 11.53 | 11.53 |
| −10b | 58.94 | NA | −13.89 | 58.94 | 19.99 | NA | 1.92 | 19.99 | 50.44 | 13.16 | −15.30 | 50.44 | 13.16 | 50.44 | 13.16 | 13.16 |
| 0a | 60.37 | NA | −6.43 | 60.37 | 20.61 | NA | 2.52 | 20.61 | 51.42 | 13.47 | −8.29 | 51.42 | 13.47 | 51.42 | 13.47 | 13.47 |
| 0b | 57.33 | NA | −4.45 | 57.33 | 19.3 | NA | 2.71 | 19.3 | 50.73 | 13.25 | −5.32 | 50.73 | 13.25 | 50.73 | 13.25 | 13.25 |
| 5a | 58.95 | NA | −0.02 | 58.95 | 19.99 | NA | 3.15 | 19.99 | 50.64 | 13.22 | −1.04 | 50.64 | 13.22 | 50.64 | 13.22 | 13.22 |
| 15a | 42.57 | NA | 10.78 | 42.57 | 13.84 | NA | 4.48 | 13.84 | 40.57 | 10.33 | 10.49 | 40.57 | 10.33 | 40.57 | 10.33 | 10.33 |

In the table above, the temperature and pressure conditions correspond to those indicated in FIGS. 2A and 2B hereof, where applicable.

From the results reported above and in FIG. 3B, it can be seen that the present thermal management system produces in this operating mode a COP on average 34.1% (22.3%-43.1%) higher than the prior heat pump systems and a heating capacity that is on average 7.0% (5.4%-9.2%) higher than the prior systems, for conditions −30a, −20a and −10a conditions.

### Example 1B1

Example 1A is repeated, except that the refrigerant blend identified in Table E1B1 below as Refrigerant RE1B1 is used instead of 1234yf under the same set of conditions identified in Table 1 above. Applicants note that the use of Refrigerant RE1B1 in this configuration of the present invention results in system operation at pressures generally higher than when using 1234yf, that is, the refrigeration system operates at pressures in the ranges typically experience with prior stationary air conditioning that use the refrigerants R404A and R410A. The present invention is thus shown to be capable of operating, particularly with Refrigerant RE1B1, within these higher pressure ranges, to achieve advantageous capacity and efficiency at such pressures while at the same time without the substantial environmental disadvantages associated with prior high GWP refrigerants.

TABLE E1B
REFRIGERANTS

| Exam- | Refrig- | ASHRAE | COMPONENTS, WT % | | | GWP |
|---|---|---|---|---|---|---|
| ple | erant | Name | R1234yf | R1132(E) | R32 | (AR4) |
| Ex1B1 | RE1B1 | R479A | 50.5 | 28 | 21.5 | 147 |

The temperatures and pressures in the respective systems in accordance with this example are reported in Table E1B1 below, with the results using the refrigerant E1B1 of this Example E1B1 reported as EWG-HP and the results from the use of the system of Comparative Example 1 reported as WG-HP.

TABLE E1B1
Temperature and pressure data - RE1B1 Refrigerant (R479C)

| | WG-HP (configuration as per solid thick lines in | | | | | | | | EWG-HP (configuration as per thick solid | | | | | | | |
|---|---|---|---|---|---|---|---|---|---|---|---|---|---|---|---|---|
| | Comparative FIG. 1) | | | | | | | | lines in FIG. 3A) | | | | | | | |
| | Condition | | | | | | | | | | | | | | | |
| | T4 | T5 | T6 | T7 | p1 | p2 | p3 | p4 | T4 | T5 | T6 | T7 | p1 | p2 | p3 | p4 |
| Units | ° C. | ° C. | ° C. | ° C. | bar | bar | bar | bar | ° C. | ° C. | ° C. | ° C. | bar | bar | bar | bar |
| −30a | 27.5 | NA | −34.4 | 27.5 | 9.81 | NA | 0.81 | 9.81 | 17.9 | 17.9 | −35.8 | 17.9 | 12.32 | 12.3 | 1.57 | 12.32 |
| −20a | 36.2 | NA | −25.88 | 36.2 | 12.22 | NA | 1.19 | 12.22 | 23.4 | 23.4 | −27.7 | 23.4 | 14.24 | 14.2 | 2.22 | 14.24 |
| −20b | 60.6 | NA | −23.0 | 60.6 | 21.38 | NA | 1.34 | 21.38 | 48.3 | 48.3 | −24.8 | 48.3 | 25.81 | 25.8 | 2.50 | 25.81 |
| −10a | 55.3 | NA | −15.7 | 55.3 | 19.44 | NA | 1.80 | 19.44 | 44.9 | 44.9 | −18.1 | 44.9 | 23.93 | 23.9 | 3.24 | 23.93 |
| −10b | 58.9 | NA | −13.8 | 58.9 | 20.63 | NA | 1.94 | 20.63 | 50.4 | 50.4 | −15.2 | 50.4 | 27.02 | 27.0 | 3.62 | 27.02 |
| 0a | 60.4 | NA | −6.3 | 60.4 | 21.27 | NA | 2.56 | 21.27 | 51.4 | 51.4 | −8.2 | 51.4 | 27.60 | 27.6 | 4.65 | 27.60 |
| 0b | 57.3 | NA | −4.3 | 57.3 | 19.91 | NA | 2.75 | 19.91 | 50.7 | 50.7 | −5.2 | 50.7 | 27.19 | 27.2 | 5.15 | 27.19 |
| 5a | 58.9 | NA | 0.0 | 58.9 | 20.63 | NA | 3.20 | 20.63 | 50.6 | 50.6 | −0.9 | 50.6 | 27.13 | 27.1 | 5.94 | 27.13 |
| 15a | 42.6 | NA | 10.8 | 42.6 | 14.25 | NA | 4.57 | 14.25 | 40.5 | 40.5 | 10.6 | 40.5 | 21.64 | 21.6 | 8.54 | 21.64 |

It is expected that the present thermal management system according to this example produces for each of the conditions using RE1B1 in this operating mode a COP that is about the same as or higher than the prior heat pump systems and a heating capacity that is about the same as or higher than the prior systems.

### Example 1C—Heat Pump Mode with Inner Evaporator/Condenser in the Loop to Warm Cabin Air and PTC Upstream of the Chiller

As with Example 1A, applicants have come to appreciate that when ambient temperatures are relatively low, EVs as previously configured, including as described in Comparative Example 1 and illustrated by the thick solid lines in Comparative FIG. 1, can have a problem with insufficient condenser surface area at the inner condenser 1 to provide complete condensation, which can result in problems with system capacity and efficiency (COP). In addition, Applicants have found that systems of the present invention as described and illustrated herein, particularly in connection with FIG. 3A, can be even further dramatically improved in terms of overall performance with relatively simple and low-cost further modifications involving primarily the relative placement of the chiller, the PTC and the coolant pump. In particular, applicant has come to appreciate that in relatively low ambient temperatures the relative power consumption associated with the operation of the coolant pump located downstream of the PTC, which itself is located downstream of the chiller, as illustrated in FIG. 3A can be undesirably high. This undesirable feature can occur due to the relatively low viscosity at the suction side of the coolant pump, which causes a potentially dramatic and undesirable increase in power consumption in the circuit. In one desirable alternative to this configuration, as illustrated in FIG. 3B, the PTC is moved to a point upstream of the chiller, which results in a reduction in the power consumption associated with the operation of the system. An illustration of using the configuration of FIG. 3B in the system as otherwise configured in FIG. 3A is illustrated in FIG. 3F.

### Example 1D—Heat Pump Mode with Inner Evaporator/Condenser in the Loop to Warm Cabin Air and PTC and Coolant Pump Upstream of the Chiller

In this Example 1D, the configuration of Example 1C is repeated, except that a further modification includes locating the coolant pump upstream of the chiller and downstream of the PTC, as illustrated in FIG. 3C. This configuration is a specially preferred, as with the configuration in Example 1C, in relatively low ambient temperatures conditions in order to minimize or at least reduce the relative power consumption associated with the operation of the coolant pump. Applicants have come to appreciate that locating both the PTC and the coolant pump upstream of the chiller, as illustrated in FIG. 3C, is even more preferred from the standpoint of minimizing the power required for the coolant pump to operate this portion of the systems of the present invention.

### Example 1E—Heat Pump Mode with Inner Evaporator/Condenser in the Loop to Warm Cabin Air and PTC Upstream of the Chiller

As with Example 1A, applicants have come to appreciate that when ambient temperatures are relatively low, EVs as previously configured, including as described in Comparative Example 1 and illustrated by the thick solid lines in Comparative FIG. 1, can have a problem with insufficient condenser surface area at the inner condenser 1 to provide complete condensation, which can result in problems with system capacity and efficiency (COP). In addition, Applicants have found that systems of the present invention as described and illustrated herein, particularly in connection with FIG. 3A, can be even further dramatically improved in terms of overall performance with relatively simple and low-cost further modifications involving primarily the relative placement of the chiller, the PTC and the coolant pump. In particular, applicant has come to appreciate that in relatively low ambient temperatures the relative power consumption associated with the operation of the coolant pump located downstream of the PTC, which itself is located downstream of the chiller, as illustrated in FIG. 3A can be undesirably high. This undesirable feature can occur due to the relatively low viscosity at the suction side of the coolant pump, which causes a potentially dramatic and undesirable increase in power consumption in the circuit. In one desirable alternative to this configuration, as illustrated in FIG. 3B, the PTC is moved to a point upstream of the chiller, which results in a reduction in the power consumption associated with the operation of the system. An illustration of a system using the configuration of FIG. 3B in the system as otherwise configured in FIG. 3A is illustrated in FIG. 3G.

### Examples 2-30 Heating and/or Cooling in Ambient Conditions from −35 C to 45 C and for Several Combinations of Heating and Cooling Needs in an EV

For the purposes of understanding the advantages and features of the present inventive system compared to prior heat pump systems over the relevant range of ambient temperature conditions and over exemplary alternative scenarios relating to heating and/or cooling needs in an operating and/or charging EV, it is noted that typical prior systems would operate in warm temperatures to primarily provide cabin air conditioning to an EV using the typical configuration illustrated by the solid thick lines in Comparative FIG. 2. In this typical prior air conditioning cycle configuration in which cabin air is to be cooled, the OHE 3 is the predominate source for condensing the refrigerant and the evaporator 2 is the cooling unit for cabin air.

Applicants have come to appreciate that while heat pump systems need an evaporative heat (energy) source, EVs also have cooling needs beyond the cooling of cabin air, that is, heat sources that represent waste heat for use as the evaporative source (highly efficient) and that the present improved system has been developed so as to take advantage of these features when possible and to achieve results not previously achievable. In particular, applicants have noted that there are two main areas that may need cooling, depending on conditions, on all EVs:
1. The battery needs cooling during charging and may, at times, need cooling during discharging (vehicle operation). The battery may also need warming initially in very cold weather.
2. The vehicle drive motor(s)/inverter require cooling during vehicle operation. These devices also benefit in efficiency from the possibility of receiving warming in cold weather.
   Unfortunately for systems of prior designs, the cooling needs and/or heating needs, and the ideal temperatures of the battery and motor/inverter, vary greatly depending on the vehicle ambient conditions, on the driving conditions, on stationary battery charging, on how long the vehicle has been off before running or on how long the vehicle has been driving. In some circumstances, one or both of these (battery or motor/inverter) may need cooling while the other does not or may need warming.

Applicants' highly flexible system is able to achieve highly efficient evaporative heat conditions using available heat while not compromising the other sources. The present system provides highly beneficial performance by unique combinations of components, including the possibility to use three evaporative heat source locations (chiller, Outside Heat Exchanger [OHE] or an Inner Heat Exchanger), while at the same time waste heat from the battery during charging and/or discharging can be used at the chiller or the OHE, and ambient air can be used at the OHE or the Inner Heat Exchanger as the heat source. In addition, one or both of the above heat sources can be warming up while another is used as the evaporative heat source for the heat pump. In addition, an electrically operated Positive Temperature Coefficient (PTC) heater can also be used alone or in series with the evaporative heat sources at the chiller and/or the OHE. The available evaporative heat sources usable according to the systems of the present invention include those listed below:
1. Air only (at the OHE)
2. Motor and inverter (at the OHE)
3. Motor and inverter (at the chiller)
4. Motor and Inverter and PTC (at the chiller)
5. Battery (at the chiller)
6. Battery and PTC (at the chiller)
7. Battery (at the OHE)
8. Motor, inverter and battery (at the chiller)
9. Motor, inverter, battery and PTC (at the chiller)
10. Motor, inverter, battery (at the OHE)
11. PTC (at the chiller)
12. PTC (at the OHE)
13. Motor, Inverter and PTC (at the OHE)
14. Motor, inverter, battery and PTC (at the OHE)
15. Battery and PTC (at the OHE)
16. Air only (at the chiller)
17. Battery, motor and inverter (at the chiller)
18. Dehumidification (at the evaporator)
   Several of many possible applicable system operating modes of the present invention for the evaporative heat sources and their use location are shown in the following Examples (with associated figures), with the relevant ambient temperatures (ambient) as well as the condition of the cabin being hot, cool, cold or acceptable to the passenger (OK). Furthermore, the condition of the battery, motor and inverter are specified as being hot, warm, cool or cold or acceptable (OK) are defined. The driving condition between start and comfort as well as the battery charge being active (Yes) or not active (No) are described. The applicable operating conditions for the different heat sources are indicated. In the Figures, thick lines in the vapor compression system indicate refrigerant flow at relatively high pressure (only line pressure drop from compressor discharge), dashed thick lines in the vapor compression system indicate refrigerant flow at a reduced pressure (after throttling in an expansion valve), and thin lines indicate refrigerant conduits (and corresponding units) that have been bypassed. Similarly, thick lines in the coolant section indicate active coolant flow and thin lines indicate coolant conduits that have been bypassed, while dashed thick lines indicate the coolant could optionally be flowing but is not for the results reported in the example.

### Example 2—Vehicle Heating Between 0° C. and 15° C.—with Evaporative Heat Source 1—Air Only at OHE and Under Applicable Conditions of 15° C., 5° C. and −5° C.

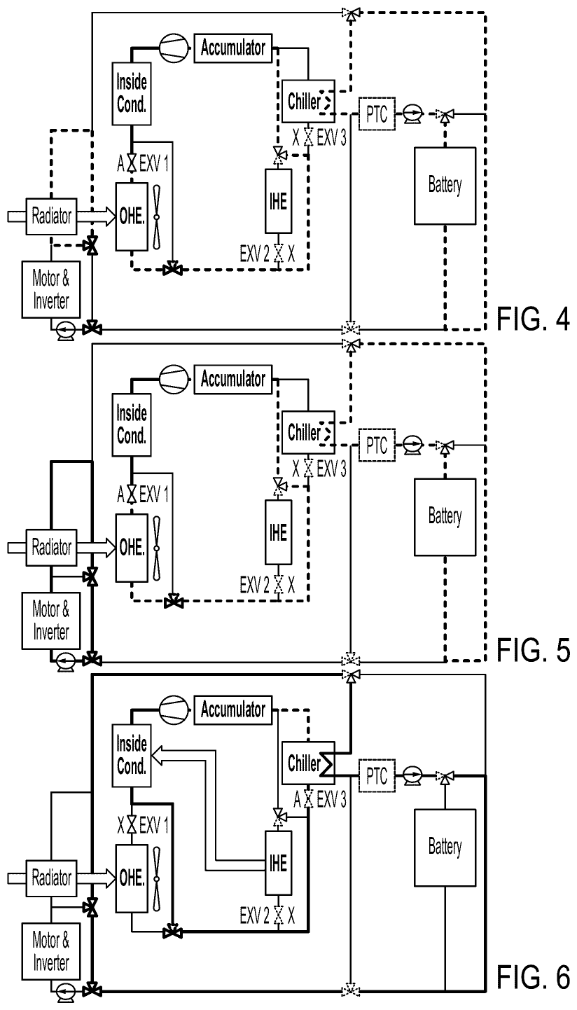

In this example, a system of the present invention configured for operation to heat cabin air during periods of low ambient temperatures is illustrated in FIG. 4. The pressure data obtained by operating the system of this example with R1234yf and with RE1B1 is reported in the following Table E2A. The use of Refrigerant RE1B1 (R4789A) is reported in Table E2B below by using bold type as an indicator for acceptable operation at the indicated locations and for indicated ambient conditions when using identified evaporative heat source(s) being used.

TABLE E2A
Temperature and pressure data For Ambient Temperature of 15° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 55.7 | NA | 10.6 | 55.7 | 18.6 | NA | 4.5 | 18.6 |
| RE1B1 | 55.7 | NA | 10.6 | 55.7 | 37.2 | NA | 8.6 | 37.2 |
| (R479A) | | | | | | | | |

TABLE E2B
Using R479A with Evaporative Heat Source 1 - Air
only at OHE and under applicable conditions of
15° C., 5° C. and −5° C.

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between 0° C. and 15° C. It can and will likely be used in conjunction with self-heating of the battery and the motor and inverter either in series or parallel.

### Example 3—Vehicle Heating Between-10° C. and 15° C.—Using R479A with Evaporative Heat Source 2: Motor and Inverter at OHE

In this example, a system of the present invention is configured for operation to heat cabin air during periods of low ambient temperatures is illustrated in FIG. 5. The data obtained by operating the system of this example with R1234yf and with REIBlis reported in the following Table E3A. The use of Refrigerant RE1B1 (R4789A) is reported in Table E3B below by using bold type as an indicator for acceptable operation at the indicated locations and for indicated ambient conditions when using the identified evaporative heat source(s).

TABLE E3A
Temperature and pressure data For Ambient Temperature of 5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | 3.4 | 59.0 | 20.0 | NA | 2.2 | 20.0 |
| RE1B1 | 59.0 | NA | 3.4 | 59.0 | 39.7 | NA | 4.3 | 39.7 |
| (R479A) | | | | | | | | |

TABLE E3B
Using R479A with Evaporative Heat
Source 2: Motor and Inverter at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −10° C. and 15° C. after the motor and inverter are warmed up and need (or can tolerate) some cooling. It can and will likely be used in conjunction with self-heating of the battery or cooling of the battery at the chiller. This can also be used to de-ice the OHE.

### Example 4—Vehicle Heating Between −15° C. and 15° C.—Evaporative Heat Source 2: Motor and Inverter at Chiller

In this example, a system of the present invention is configured for operation to heat cabin air during periods of low ambient temperatures is illustrated in FIG. 6. The data obtained by operating the system of this example with R1234yf and with RE1B1 produces the results as reported in the following Table E4A. The use of Refrigerant RE1B1 (R4789A) is reported in Table E4B below by using bold type as an indicator for acceptable operation at the indicated locations and for indicated ambient conditions when using the identified evaporative heat source(s).

TABLE E4A
Temperature and pressure data For Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −13.05 | 62.3 | 21.5 | NA | 2.0 | 21.5 |
| RE1B1 | 62.3 | NA | −13.05 | 62.3 | 37.2 | NA | 8.6 | 37.2 |
| (R479A) | | | | | | | | |

TABLE E4B
Evaporative heat source 2: Motor and Inverter at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between-15° C. and 15° C. after the motor and inverter are warmed up and need or can tolerate some cooling. It can also be used to cool the motor and inverter in warm weather. It will likely be used when the battery is at an appropriate or acceptable temperature.

### Example 5—Motor and Inverter Temperature Control while Heating the EV—Evaporative Heat Source 4: Motor, Inverter and PTC at Chiller

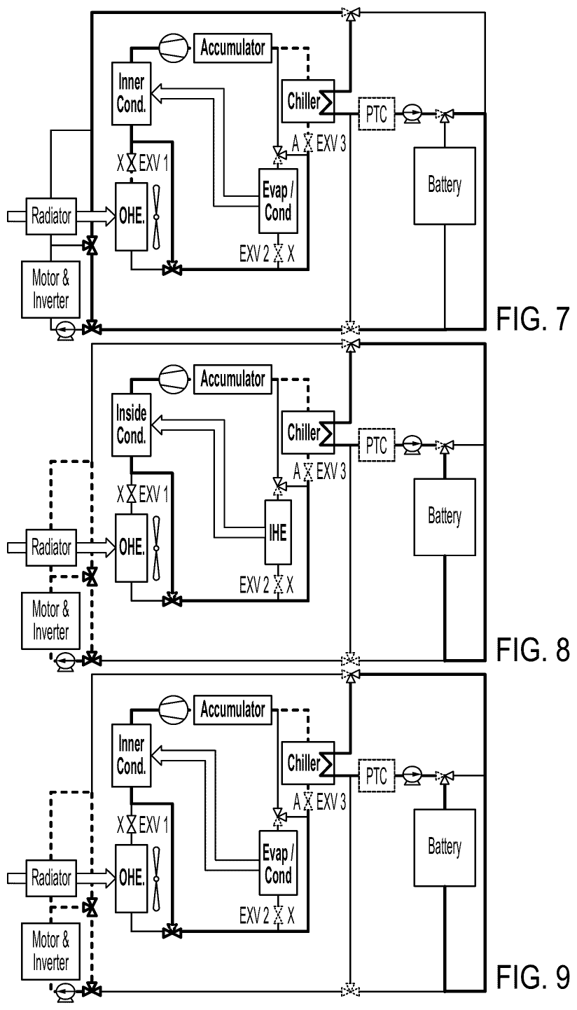

In this example, a system of the present invention configured for operation to heat cabin air during periods of low ambient temperatures is illustrated in FIG. 7. The data obtained by operating the system with R1234yf and with RE1B1 is reported in the following Table E5A. The use of Refrigerant RE1B1 (R4789A) is reported in Table E5B below by using bold type as an indicator for acceptable operation at the indicated locations and for indicated ambient conditions when using the identified evaporative heat source(s).

TABLE E5A
Temperature and pressure data For Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −13.05 | 62.3 | 21.5 | NA | 2.0 | 21.5 |
| RE1B1 | 62.3 | NA | −13.05 | 62.3 | 42.3 | NA | 3.9 | 42.3 |
| (R479A) | | | | | | | | |

TABLE E5B
Evaporative Heat Source 4: Motor, Inverter and PTC at chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | Nc |

In this mode the motor and inverter temperature can be maintained while heating the vehicle. In this case, the battery is assumed to be warming up while charging or at an appropriate temperature.

### Example 6A—Vehicle Heating Between −25° C. and 5° C. With Battery Charging—Evaporative Heat Source 5: Motor, Inverter and PTC at Chiller

In this example, a system of the present invention configured for operation to heat cabin air during periods of low ambient temperatures is illustrated in FIG. 8 and FIGS. 3A and 3B. The data obtained by operating the system of this example with R1234yf and with RE1B1 is reported in the following Table E6A. The use of Refrigerant RE1B1 (R4789A) is reported in Table E6B below by using bold type as an indicator for acceptable operation at the indicated locations and for indicated ambient conditions when using the identified evaporative heat source(s).

TABLE E6
Temperature and pressure data for Ambient
Temperature of −15° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 60.6 | NA | −8.94 | 60.6 | 20.7 | NA | 2.3 | 20.7 |
| RE1B1 | 60.6 | NA | −8.94 | 60.6 | 41.0 | NA | 4.5 | 41.0 |
| (R479A) | | | | | | | | |

TABLE E6B
Evaporative Heat Source 5: Motor, Inverter and PTC at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −25° C. and 5° C. while the battery is charging. Excess heat from charging or from the charging source can be used to heat the vehicle.

### Example 7A—Vehicle Heating with Ambient Between −35° C. and 5° C. With Battery Charging—Evaporative Heat Source 5: Motor, Inverter and PTC at Chiller

In this example, a system of the present invention configured for operation to heat cabin air during periods of low ambient temperatures is illustrated in FIG. 9 and FIGS. 3A and 3B. This system is operated with R1234yf and with RE1B1 and produces the results as reported in the following Table E7A. The use of Refrigerant RE1B1 (R479A) is reported in Table E7B below by using bold type as an indicator for acceptable operation at the indicated locations and for indicated ambient conditions when using the identified evaporative heat source(s).

TABLE E7A
Temperature and pressure data for Ambient
Temperature of −25° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 60.7 | NA | 5.6 | 60.7 | 20.8 | NA | 3.8 | 20.8 |
| RE1B1 | 60.7 | NA | 5.6 | 60.7 | 41.0 | NA | 7.3 | 41.0 |
| (R479A) | | | | | | | | |

TABLE E7B
Evaporative Heat Source 5: Motor, Inverter and PTC at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating while maintaining the battery temperature between ambient conditions of −35° C. and 5° C. This mode would likely be used at the start of a drive after charging.

### Example 8—Vehicle Heating with Ambient Between −15° C. and 5° C. With Battery Charging—Evaporative Heat Source 7: Battery, PTC and Air at OHE

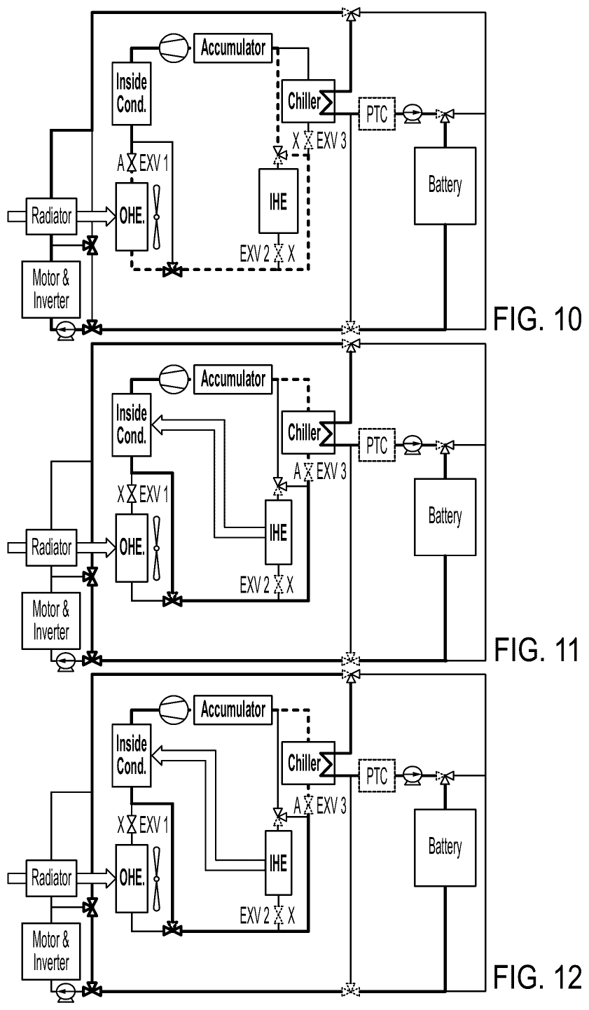

In this example, a system of the present invention configured for operation to heat cabin air during periods of low ambient temperatures is illustrated in FIG. 10 and FIGS. 3A and 3B. This system is operated with R1234yf and with REIBland produces the results as reported in the following Table E8A. The use of Refrigerant RE1B1 (R4789A) is reported in Table E8B below by using bold type as an indicator for acceptable operation at the indicated locations and for indicated ambient conditions when using the identified evaporative heat source(s).

TABLE E8A
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | −6.69 | 59.0 | 20.0 | NA | 2.5 | 20.0 |
| RE1B1 | 59.0 | NA | −6.69 | 59.0 | 39.7 | NA | 4.9 | 39.7 |
| (R479A) | | | | | | | | |

TABLE E8B
Evaporative Heat Source 7: Battery, PTC and Air at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 5° C. while the battery is charging. Excess heat from charging can be used to heat the vehicle at the OHE.

### Example 9—Vehicle Heating with Ambient Between −15° C. and 15° C. While Driving—Evaporative Heat Source 8: Inverter and Battery at Chiller

In this example, a system of the present invention configured for operation to heat cabin air during periods of low ambient temperatures is illustrated in FIG. 11. This system is operated with R1234yf and with RE1B1 and produces the results as reported in the following Table E9A. The use of Refrigerant RE1B1 (R4789A) is reported in Table E9B below by using bold type as an indicator for acceptable operation at the indicated locations and for indicated ambient conditions when using the identified evaporative heat source(s).

TABLE E9A
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −13.27 | 62.3 | 21.5 | NA | 2.0 | 21.5 |
| RE1B1 | 62.3 | NA | −13.27 | 62.3 | 42.3 | NA | 3.9 | 42.3 |
| (R479A) | | | | | | | | |

TABLE E9B
Evaporative Heat Source 8: Inverter and Battery at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 15° C. while driving. Excess heat from the battery and motor and inverter can be used at the chiller. This can also be used with the enhanced heat pump configuration (dotted line).

### Example 10—Vehicle Heating with Ambient Between −25° C. and 5° C. While Driving—Evaporative Heat Source 9: Motor, Inverter, Battery and PTC at Chiller

In this example, a system of the present invention configured for operation to heat cabin air during periods of low ambient temperatures is illustrated in FIG. 12. This system is operated with R1234yf and with RE1B1 and produced the results as reported in the following Table E10A. The use of Refrigerant RE1B1 (R4789A) is reported in Table E10B below by using bold type as an indicator for acceptable operation at the indicated locations and for indicated ambient conditions when using the identified evaporative heat source(s).

TABLE E10
Temperature and pressure data for Ambient
Temperature of −15° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.6 | NA | 22.77 | 59.6 | 20.3 | NA | 6.4 | 20.3 |
| RE1B1 | 59.6 | NA | 22.77 | 59.6 | 40.1 | NA | 12.2 | 40.1 |
| (R479A) | | | | | | | | |

TABLE E10B
Evaporative Heat Source 9: Motor, Inverter,
Battery and PTC at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −25° C. and 5° C. while driving. PTC heat can be used to heat the vehicle while maintaining the battery and motor and inverter temperatures. This can also be used with the enhanced heat pump configuration (dotted line).

### Example 11—Vehicle Heating with Ambient Between −15° C. and 15° C. While Driving—Evaporative Heat Source 10: Motor, Inverter, Battery at OHE

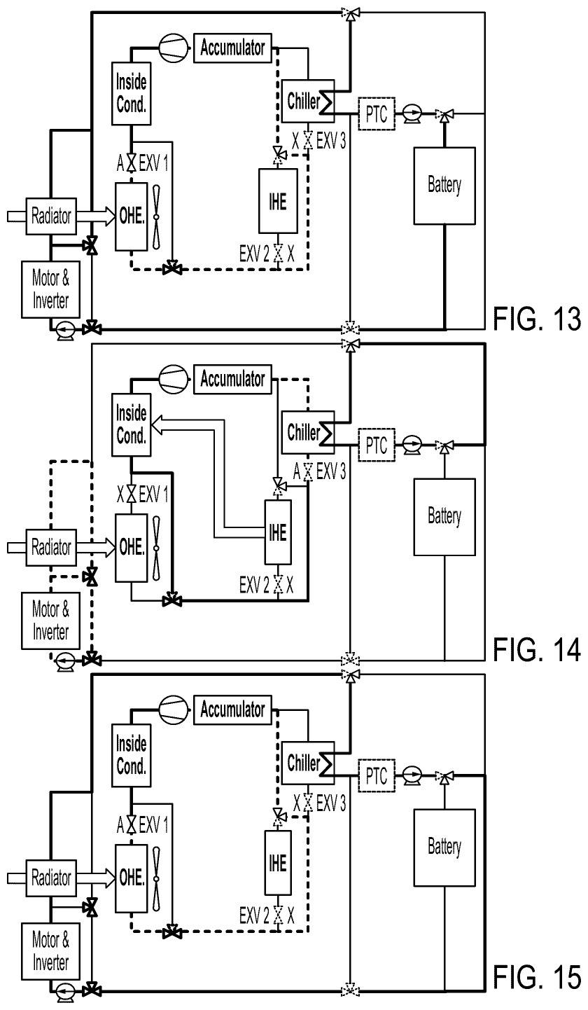

In this example, a system of the present invention configured for operation to heat cabin air during periods of low ambient temperatures is illustrated in FIG. 13. This system is operated with R1234yf and with RE1B1 and produces the results as reported in the following Table E11A. The use of Refrigerant RE1B1 (R4789A) is reported in Table E11B below by using bold type as an indicator for acceptable operation at the indicated locations and for indicated ambient conditions when using the identified evaporative heat source(s).

TABLE E11A
Temperature and pressure data for Ambient Temperature of 5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 59.0 | NA | 2.55 | 59.0 | 20.0 | NA | 3.4 | 20.0 |
| RE1B1 | 59.0 | NA | 2.55 | 59.0 | 39.7 | NA | 6.7 | 39.7 |
| (R479A) | | | | | | | | |

TABLE E11B
Evaporative Heat Source 10: Motor, inverter, battery at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | Nc |
| −35 | Cool | Cool | Cool | Start | Yes |
| | Cold | Cold | Cold | Comfort | No |

This is an efficient mode for vehicle heating between −15° C. and 15° C. while driving. Excess heat from the battery and motor and inverter can be used at the OHE. This can also be used to defrost the OHE in the event of freezing.

### Example 12—Vehicle Heating with Ambient Between −35° C. and 5° C. With Battery Charging—Evaporative Heat Source 11: PTC at Chiller

In this example, a system of the present invention configured for operation to heat cabin air during periods of low ambient temperatures is illustrated in FIG. 14. This system is operated with R1234yf and with RE1B1 and produces the results as reported in the following Table E12A. The use of Refrigerant RE1B1 (R4789A) is reported in Table E12B below by using bold type as an indicator for acceptable operation at the indicated locations and for indicated ambient conditions when using the identified evaporative heat source(s).

TABLE E12A
Temperature and pressure data for Ambient
Temperature of −25° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 60.9 | NA | −7.04 | 60.9 | 20.8 | NA | 2.5 | 20.8 |
| RE1B1 | 60.9 | NA | −7.04 | 60.9 | 41.2 | NA | 4.9 | 41.2 |
| (R479A) | | | | | | | | |

TABLE E12B
Evaporative Heat Source 11: PTC at Chiller

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −35° C. and −5° C. after charging to prep the vehicle cabin before driving. Heat from the PTC is used by the heat pump to warm the cabin. This can also be used with the enhanced heat pump configuration (dotted line).

### Example 13—Vehicle Heating with Ambient Between −15° C. and 5° C. With Battery Charging or Driving—Evaporative Heat Source 12: PTC at OHE

In this example, a system of the present invention configured for operation to heat cabin air during periods of low ambient temperatures is illustrated in FIG. 15. This system is operated with R1234yf and with RE1B1 and produces the results as reported in the following Table E13A. The use of Refrigerant RE1B1 (R479A) is reported in Table E13B below by using bold type as an indicator for acceptable operation at the indicated locations and for indicated ambient conditions when using the identified evaporative heat source(s).

TABLE E13A
Temperature and pressure data for Ambient Temperature of −5° C.

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 62.3 | NA | −7.27 | 62.3 | 21.5 | NA | 2.4 | 21.5 |
| RE1B1 | 62.3 | NA | −7.27 | 62.3 | 42.3 | NA | 4.8 | 42.3 |
| (R479A) | | | | | | | | |

TABLE E13B
Evaporative Heat Source 12: PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is an efficient mode for vehicle heating between −15° C. and 5° C. while driving or charging when the battery and motor and inverter are at appropriate temperatures. Heat from the PTC can be used at the OHE.

### Example 14—Vehicle Heating with Ambient Between −15° C. and 5° C.—Evaporative Heat Source 13: Motor, Inverter and PTC at OHE

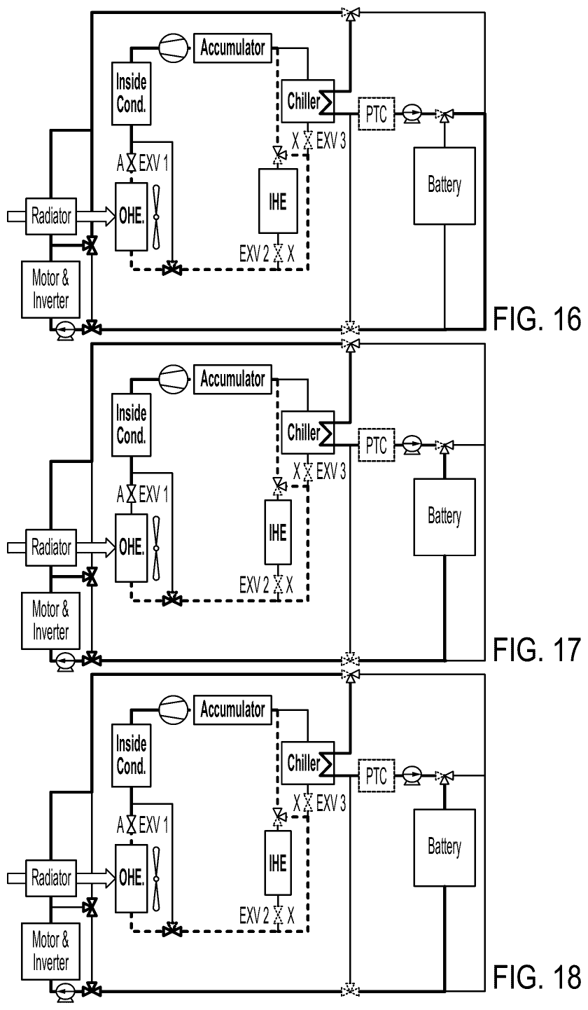

In this example, a system of the present invention configured for operation to heat cabin air during periods of low ambient temperatures is illustrated in FIG. 16 and is operated with R1234yf and with RE1B1. The use of Refrigerant RE1B1 (R479A) is reported in Table E14 below by using bold type as an indicator for acceptable operation at the indicated locations and for indicated ambient conditions when using the identified evaporative heat source(s).

TABLE E14
Evaporative Heat Source 13: Motor, Inverter and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 5° C. while the motor and inverter are warming up (the PTC energy can be used in this mode). This mode of operation can also be used to de-ice the OHE.

### Example 15—Vehicle Heating with Ambient Between −15° C. and 5° C. With Battery Charging—Evaporative Heat Source 14: Motor, Inverter, Battery and PTC at OHE

In this example, a system of the present invention is configured for operation to heat cabin air during periods of low ambient temperatures is illustrated in FIG. 17 and is operated with R1234yf and with RE1B1. The use of Refrigerant RE1B1 (R479A) is reported in Table E15 below by using bold type as an indicator for acceptable operation at the indicated locations and for indicated ambient conditions when using the identified evaporative heat source(s).

TABLE E15
Evaporative Heat Source 14: Motor,
Inverter, Battery and PTC at OHE

| Ambient, | | | Motor & | | |
|---|---|---|---|---|---|
| ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | Nc |

This is a less efficient mode for vehicle heating between −15° C. and 15° C. while the motor and inverter and battery are warming up (the PTC energy can be used). This can also be used to de-ice the OHE.

### Example 16—Vehicle Heating with Ambient Between −15° C. and 15° C. With Component Warm Up—Evaporative Heat Source 15: Battery and PTC at OHE

In this example, a system of the present invention configured for operation to heat cabin air during periods of low ambient temperatures is illustrated in FIG. 18 and is operated with R1234yf and with RE1B1. The use of Refrigerant RE1B1 (R479A) is reported in Table E16 below by using bold type as an indicator for acceptable operation at the indicated locations and for indicated ambient conditions when using the identified evaporative heat source(s).

TABLE E16
Evaporative Heat Source 15: Battery and PTC at OHE

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is a less efficient mode for vehicle heating between −15° C. and 15° C. while the motor and inverter and battery are warming up (the PTC energy can be used). This can also be used to de-ice the OHE.

### Example 17—Vehicle Heating with Ambient Between −15° C. and 5° C.—Evaporative Heat Source 16: Radiator (Air) at Chiller

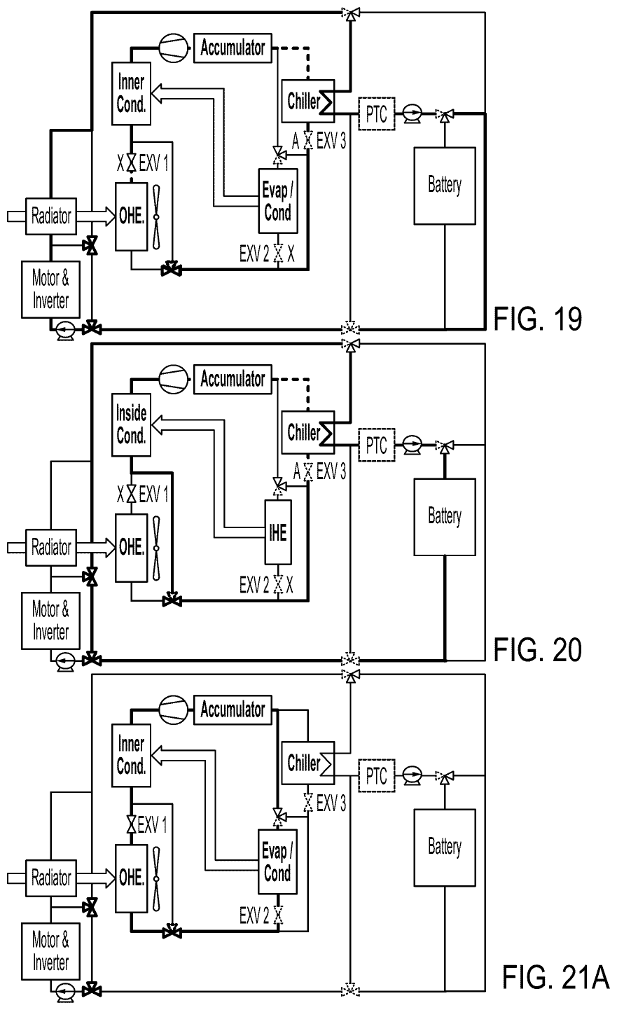

In this example, a system of the present invention configured for operation to heat cabin air during periods of low ambient temperatures is illustrated in FIG. 19 and is operated with R1234yf and with RE1B1. The use of Refrigerant RE1B1 (R479A) is reported in Table E17 below by using bold type as an indicator for acceptable operation at the indicated locations and for indicated ambient conditions when using the identified evaporative heat source(s).

TABLE E17
Evaporative Heat Source 16: Radiator (Air) at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between −5° C. and 15° C. Energy from the air can be used at the chiller while not affecting the motor and Inverter or the battery.

### Example 18—Vehicle Heating with Ambient Between −15° C. and 5° C. After Component Warm-Up—Evaporative Heat Source 17: Battery, Motor and Inverter at Chiller

In this example, a system of the present invention configured for operation to heat cabin air during periods of low ambient temperatures is illustrated in FIG. 20 and is operated with R1234yf and with RE1B1. The use of Refrigerant RE1B1 (R479A) is reported in Table E18 below by using bold type as an indicator for acceptable operation at the indicated locations and for indicated ambient conditions when using the identified evaporative heat source(s).

TABLE E18
Evaporative Heat Source 17: Battery, Motor and Inverter at Chiller

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is also an efficient mode for vehicle heating between-15° C. and 15° C. after the motor and inverter and battery are warmed up and need (or can tolerate) some cooling. It can also be used to cool the motor and inverter and battery in warm weather.

### Example 19A—De-Humidification—Evaporative Heat Source 18: Dehumidification at Evaporator

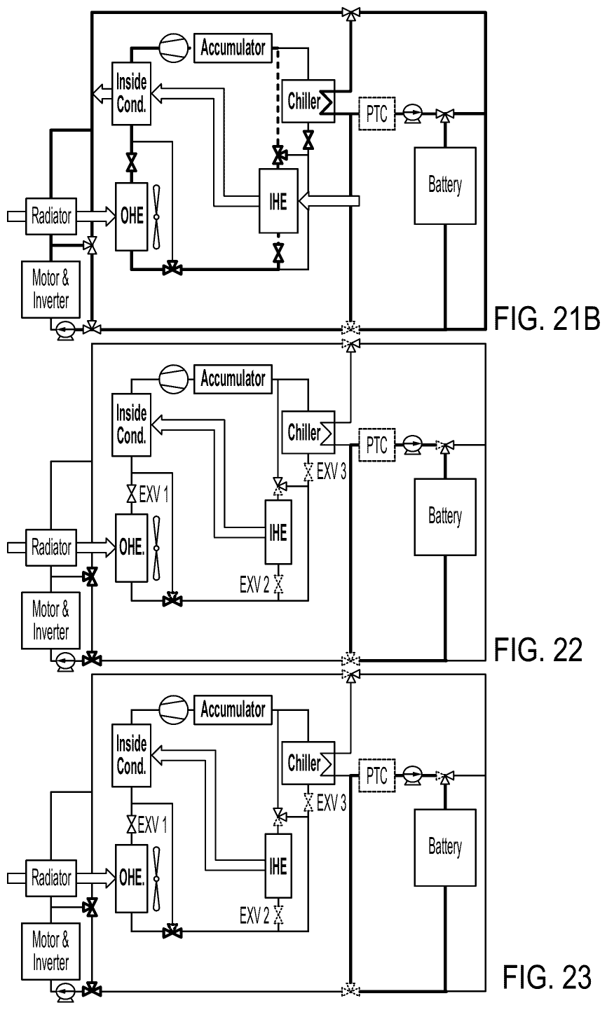

In this example, a system of the present invention configured for operation to heat cabin air during periods of normal ambient temperatures is illustrated in FIG. 21A. This system is operated with R1234yf and with RE1B1 and produces the results as reported in the following Table E19AA. The use of Refrigerant RE1B1 (R479A) is reported in Table E19AB below by using bold type as an indicator for acceptable operation at the indicated locations and for indicated ambient conditions when using the identified evaporative heat source(s).

TABLE E19AA
Temperature and pressure data for Ambient Temperature of 25°
C. - Evaporative Heat Source 18: Dehumidification at Evaporator

| | T4 | T5 | T6 | T7 | p1 | p2 | p3 | p4 |
|---|---|---|---|---|---|---|---|---|
| Refrigerant | [C.] | [C.] | [C.] | [C.] | [bar] | [bar] | [bar] | [bar] |
| R-1234yf | 25.0 | 17.04 | NA | 35.0 | 9.0 | NA | 5.4 | 9.0 |
| RE1B1 | 25.0 | 17.04 | NA | 35.0 | 19.0 | NA | 10.3 | 19.0 |
| (R479A) | | | | | | | | |

TABLE E19AB
Evaporative Heat Source 18: Dehumidification at Evaporator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This is the normal mode for dehumidification where the air is cooled (below the dew point to remove moisture) and then reheated to achieve a more comfortable temperature for passengers. In very warm weather there would be less or no reheat but in milder conditions dehumidification is necessary.

### Example 19B—De-Humidification—Using Inside Condenser for Dehumidification Reheat

In this example, a system of the present invention configured for operation to heat cabin air during periods of normal ambient temperatures is illustrated in FIG. 21B and is operated with RE1B1.

### Examples 20-27

In addition to the evaporative heat source flexibility provided by the present invention, several energy saving, warming and cooling configurations are advantageously provided. The configurations shown on the following page show energy saving opportunities for many conditions.
Warming the battery with self-heating
Warming the battery with PTC heating
Warming the motor and inverter with self-heating
Warming the motor and inverter with PTC
Warming the battery, motor and inverter with self-heating
Warming the battery, motor and inverter with PTC
Cooling the motor and inverter at the radiator
Cooling the motor and inverter @ the radiator (Battery @ chiller)
Cooling the battery at the radiator
Cooling the motor, inverter and battery at the radiator

### Example 20—Battery Warming—Warming the Battery (Self-Heating)

In this example, a system of the present invention configured for operation to heat cabin air during periods of low ambient temperatures while also warming the battery is illustrated in FIG. 22 and is operated with R1234yf and with RE1B1. The use of Refrigerant RE1B1 (R4789A) is reported in Table E20 below by using bold type as an indicator for acceptable operation at the indicated locations and for indicated ambient conditions when using the identified evaporative heat source(s).

TABLE E20
Warming the Battery (Self-Heating)

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant to the battery helps the battery warm up more consistently either when charging or while driving.

### Example 21—Batter Heating—Very Cold Ambient—Warming the Battery with PTC

In this example, a system of the present invention configured for operation to heat cabin air during periods of very low ambient temperatures is illustrated in FIG. 23 and is operated with RE1B1. The use of Refrigerant RE1B1 (R479A) is reported in Table E21 below by using bold type as an indicator for acceptable operation at the indicated locations and for indicated ambient conditions when using the identified evaporative heat source(s).

TABLE E21
Warming the Battery with PTC

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In cool to very cold weather the battery can be heated by circulating coolant heated by the PTC. This could be necessary before charging the battery in very cold weather. This could also improve charging time (decrease) in more mild but cool conditions. This could also be used to warm up the battery at the beginning of the drive cycle. 5

### Example 22—Motor and Inverter Self Heating—Warming the Motor and Inverter (Self-Heating)

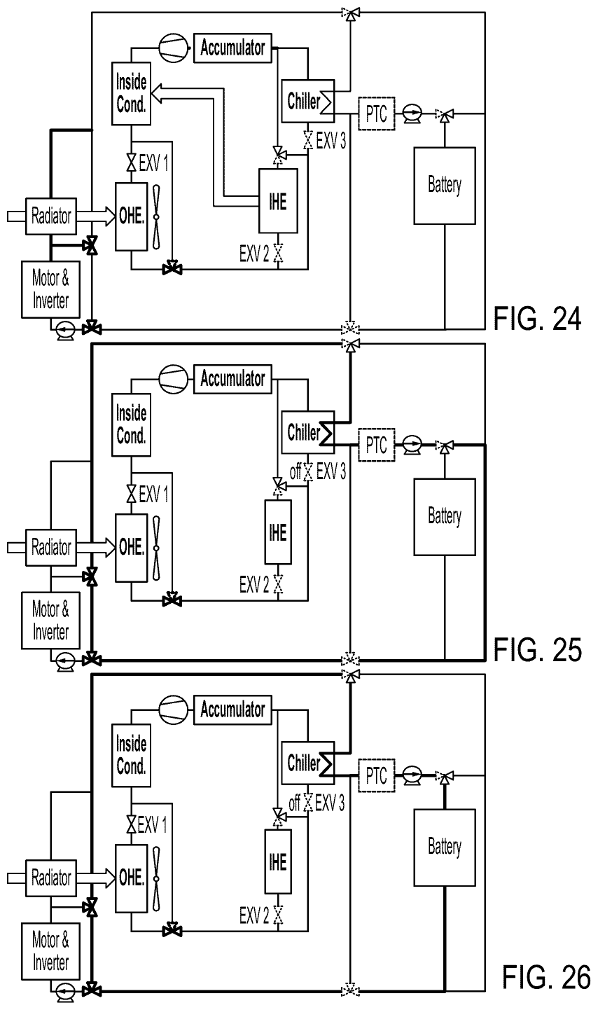

In this example, a system of the present invention configured for operation to heat cabin air during periods of low ambient temperatures is illustrated in FIG. 24 and is operated with RE1B1. The use of Refrigerant RE1B1 (R479A) is reported in Table E22 below by using bold type as an indicator for acceptable operation at the indicated locations and for indicated ambient conditions when using the identified evaporative heat source(s).

TABLE E22
Warming the Motor and Inverter (Self-Heating)

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | Nc |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Allowing the motor and inverter in cold to cool weather to uniformly self-heat is important to achieve the best efficiency. Coolant can be circulated without removing heat.

### Example 23—Motor and Inverter Self Heating—Warming the Motor and Inverter (Self-Heating)

In this example, a system of the present invention configured for operation to heat cabin air during periods of low ambient temperatures is illustrated in FIG. 25 and is operated with RE1B1. The use of Refrigerant RE1B1 (R479A) is reported in Table E23 below by using bold type as an indicator for acceptable operation at the indicated locations and for indicated ambient conditions when using the identified evaporative heat source(s).

TABLE E23
Warming the Motor and Inverter (Self-Heating)

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Allowing the motor and Inverter in cold to cool weather to uniformly self-heat is important to achieve the best efficiency. PTC heat can be used to speed up the warmup. This may improve vehicle efficiency after charging and just prior to drive start.

### Example 24—Battery, Motor and Inverter Heating—Warming the Battery, Motor and Inverter with Self Heating

In this example, a system of the present invention configured for operation to heat cabin air during periods of low ambient temperatures is illustrated in FIG. 26 and is operated with RE1B1. Circulating coolant through the motor/inverter and battery would be an efficient way to warm both devices. The use of Refrigerant RE1B1 (R479A) is reported in Table E24 below by using bold type as an indicator for acceptable operation at the indicated locations and for indicated ambient conditions when using the identified evaporative heat source(s).

TABLE E24
Warming the Battery, Motor and Inverter with Self Heating

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This would likely be used during charging until cooling is necessary for the battery. It could also be used during driving to warm the battery until the desired temperature is reached when the battery would be removed from the loop.

### Example 25—Battery, Motor and Inverter Self Heating—Warming the Battery, Motor and Inverter with PTC

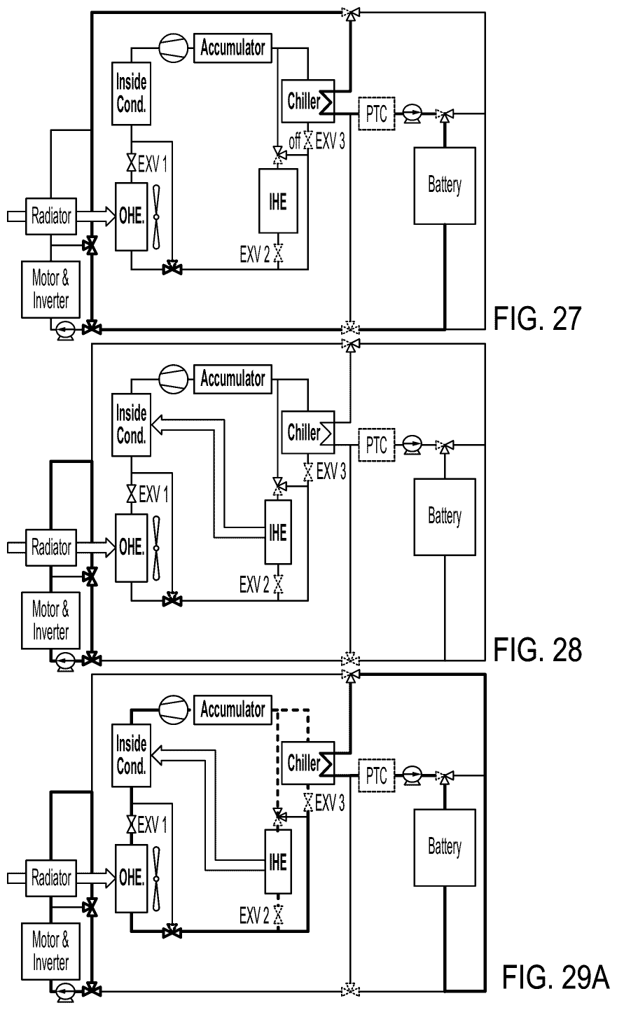

In this example, a system of the present invention configured for operation to heat cabin air during periods of low ambient temperatures is illustrated in FIG. 27 and is operated with RE1B1. The use of Refrigerant RE1B1 (R479A) is reported in Table E25 below by using bold type as an indicator for acceptable operation at the indicated locations and for indicated ambient conditions when using the identified evaporative heat source(s).

TABLE E25
Warming the Battery, Motor and Inverter with PTC

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

Circulating coolant through the motor/inverter and battery would be an efficient way to warm both devices. PTC heat could also be used to augment the warming. This would be appropriate while or prior to charging.

### Example 26—Motor and Inverter Cooling—Cooling the Motor and Inverter at the Radiator

In this example, a system of the present invention configured for operation to heat cabin air during periods of low ambient temperatures is illustrated in FIG. 28 and is operated with RE1B1. The use of Refrigerant RE1B1 (R479A) is reported in Table E26 below by using bold type as an indicator for acceptable operation at the indicated locations and for indicated ambient conditions when using the identified evaporative heat source(s).

TABLE E26
Cooling the Motor and Inverter at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many ambient driving conditions, it should be very efficient to cool the motor and inverter at the radiator as necessary without increasing the load on the AC system (at the chiller) which takes additional energy that is likely being used to keep the vehicle cool.

### Example 27—Motor and Inverter Self Heating—Cooling the Motor and Inverter at the Radiator

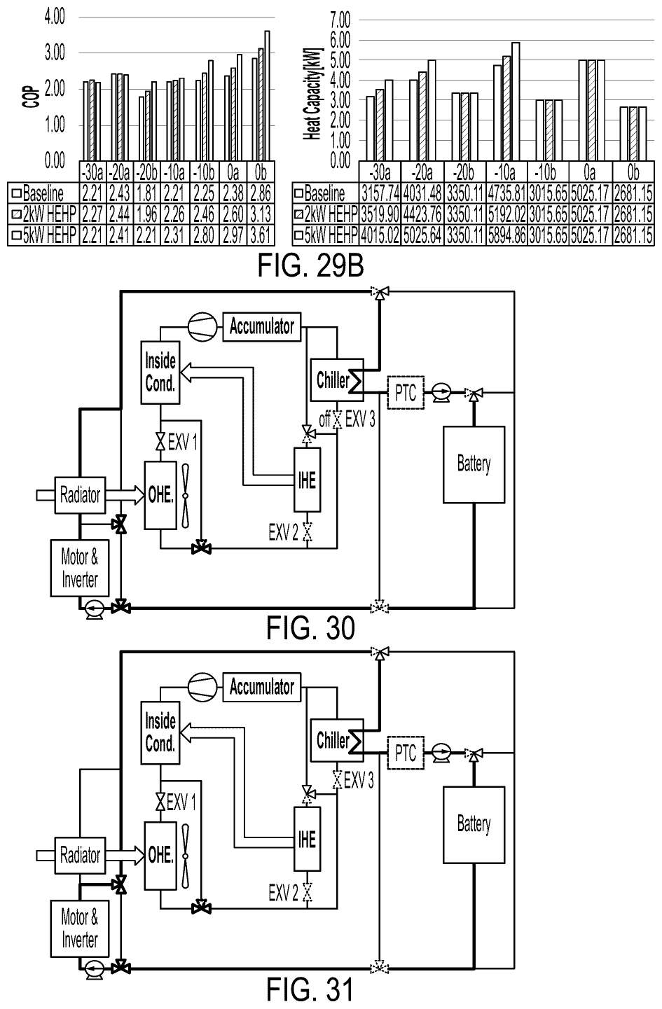

In this example, a system of the present invention configured for operation to heat cabin air during periods of low ambient temperatures is illustrated in FIG. 29A and is operated with RE1B1. The use of Refrigerant RE1B1 (R479A) is reported in Table E27 below by using bold type as an indicator for acceptable operation at the indicated locations and for indicated ambient conditions when using the identified evaporative heat source(s).

TABLE E27
Cooling the Motor and Inverter at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

This mode (cooling the motor and inverter at the radiator) could also be used while cooling the battery at the Chiller. This would be the predominant component cooling mode in warm to hot weather. The Evaporator is used to cool the vehicle. In such a mode where the OHE is used, enhanced performance can be expected for such systems in this and/or similar configurations in which the OHE is used.

The COP and heat capacity of the system operating in three modes according to this example is approximated by the results shown in FIG. 29B.

### Example 28—Battery Cooling—Cooling of the Battery at the Radiator

In this example, a system of the present invention configured for operation to heat cabin air during periods of low ambient temperatures is illustrated in FIG. 30 and is operated with RE1B1. The use of Refrigerant RE1B1 (R479A) is reported in Table E28 below by using bold type as an indicator for acceptable operation at the indicated locations and for indicated ambient conditions when using the identified evaporative heat source(s).

TABLE E28
Cooling of the Battery at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many ambient cases the battery could also be cooled at the radiator to reduce energy usage (over the chiller). In warm to mild conditions this will be used during charging to remove heat from the battery.

### Example 29-Battery, Motor and Inverter Self Heating—Cooling of the Battery at the Radiator

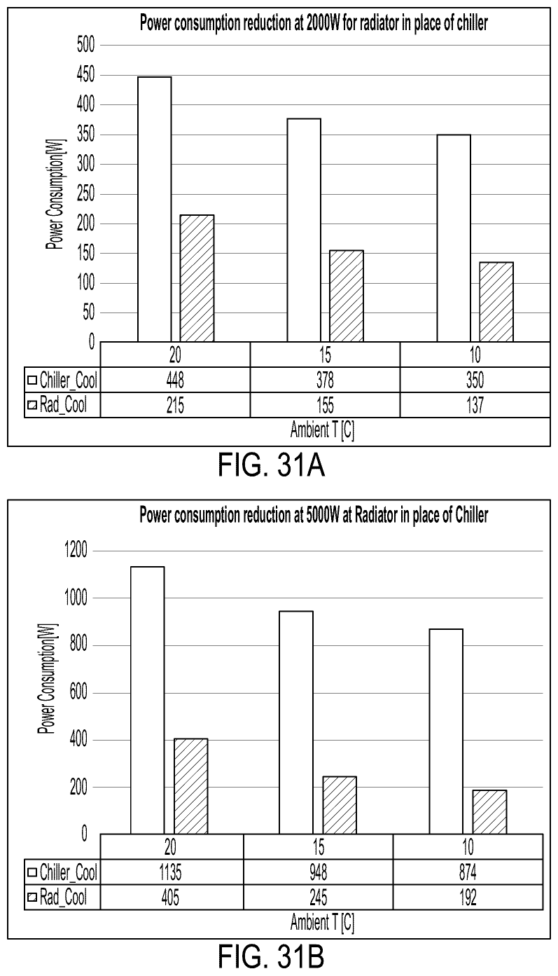

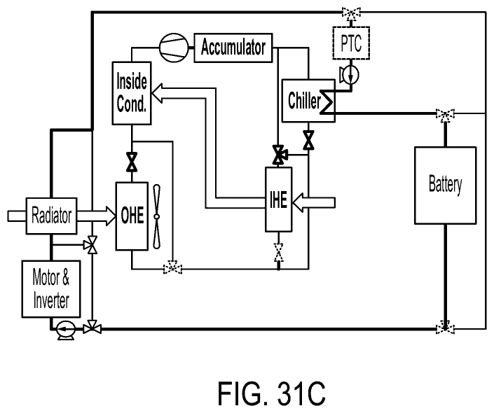

In this example, a system of the present invention configured for operation to heat cabin air during periods of low ambient temperatures is illustrated in FIG. 31 and is operated with RE1B1. The use of Refrigerant RE1B1 (R479A) is reported in Table E29 below by using bold type as an indicator for acceptable operation at the indicated locations and for indicated ambient conditions when using the identified evaporative heat source(s).

TABLE E29
Cooling of the Battery at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | No |

In many conditions, the motor, inverter and battery can be cooled at the radiator reducing energy consumption at the chiller. In cool to warm conditions this might be the predominant method of cooling the components.

### Example 30A—Embodiments—Enhanced Efficiency without Compressor—Cooling of the Battery at the Radiator

In this example, a system of the present invention configured for operation to heat cabin air during periods of low ambient temperatures is illustrated in FIG. 31 and FIG. 3D, and is operated with RE1B1. In particular, a second coolant pump is located down stream of the battery and upstream of the motor/inverter and directs the coolant through the radiator and back to the first liquid pump. In preferred embodiments, with piping and valving are preferably arranged to allow the options of allowing at least a portion and possibly all (in which case the second liquid pump would not need to be in operation) of the coolant to be diverted around the motor inverter and directly to the radiator. In preferred embodiments, the coolant in such an arrangement is able to cool the battery to within a temperature range of about 25° C.-35° C. and to cool motor/inverter temperatures to within about 40° C. to about 65° C. For operation in which ambient air is at about 15° C., the coolant (preferably water/glycol) would exit the radiator and return to the first liquid pump (with the chiller and the PTC not operating as heat transfer devices in this mode) at a temperature of about 20° C. An exemplary version of this configuration is illustrated in FIG. 31C, with the additional enhancement of using hot radiator air at the OHE and/or the IHE and/or the inner condenser in order to provide necessary heating to the cabin air.

The use of Refrigerant RE1B1 (R479A) is reported in Table E30A below by using bold type as an indicator for acceptable operation at the indicated locations and for indicated ambient conditions when using the identified evaporative heat source(s).

TABLE E30A
Cooling of the Battery at the Radiator

| | | | Motor & | | |
|---|---|---|---|---|---|
| Ambient, ° C. | Cabin | Battery | Inverter | Driving | Charging |
| 45 | Hot | Hot | Hot | Start | Yes |
| | OK | Warm | Warm | Comfort | No |
| 35 | Hot | Hot | Hot | Start | Yes |
| | OK | Warm | Warm | Comfort | No |
| 25 | Hot | Hot | Hot | Start | Yes |
| | OK | Warm | Warm | Comfort | No |
| 15 | OK | Warm | Warm | Start | Yes |
| | Cool | Cool | Cool | Comfort | No |
| 5 | OK | OK | OK | Start | Yes |
| | Cool | Cool | Cool | Comfort | No |
| −5 | OK | OK | OK | Start | Yes |
| | Cold | Cold | Cold | Comfort | No |
| −15 | OK | OK | OK | Start | Yes |
| | Cold | Cold | Cold | Comfort | No |
| −25 | Cool | Cool | Cool | Start | Yes |
| | Cold | Cold | Cold | Comfort | No |
| −35 | Cool | Cool | Cool | Start | Yes |
| | Cold | Cold | Cold | Comfort | Nc |

However, in this example, the present system provides operation as a heat pump in an EV to achieve efficiency improvement by rejecting heat without running the compressor and using radiator heat dissipation as opposed to using the chiller, as illustrated by the performance data for this Example 30A as shown in FIGS. 31A and 31B.

What is claimed is:

1. A heat transfer system to alternatively and/or simultaneously provide heating and/or cooling in a mobile vehicle that includes an electrical power source requiring heating and/or cooling during charging and/or operation and that includes a cabin that requires heat input during low temperature ambient conditions, said system comprising:
a) a vapor compression refrigeration circuit located in said mobile vehicle comprising:
(i) a heat transfer composition comprising a first refrigerant comprising from about 48% to about 52% by weight of 2,3,3,3-tetrafluoropropene (R1234yf), from about 20% to about 23% by weight of R32 and from about 26% to about 30% of R1132(E),
(ii) a compressor for compressing said first refrigerant in the vapor state from a first pressure to a higher second pressure,
(iii) an inner condenser for selectively condensing during low temperature ambient conditions at least a portion of said first refrigerant vapor from said compressor by rejecting heat to said cabin,
(iv) an outside heat exchanger located downstream of said inner condenser to selectively either (1) condense during low temperature ambient conditions at least a portion of said higher pressure refrigerant vapor not condensed in said inner condenser by rejecting heat, directly or indirectly, to ambient air and/or to a circulating coolant or (2) evaporate during high temperature ambient conditions low pressure refrigerant liquid from said inner condenser vapor;
(v) a first OCE connected between said inner condenser and said outside heat exchanger for selectively (1) providing in an expansion mode a flow of reduced pressure liquid refrigerant from said inner condenser to said outside heat exchanger; (2) allowing in an open mode said condensed high pressure refrigerant from said condenser to pass to said outside condenser without pressure drop to said outside heat exchanger; or (3) preventing in a closed mode the flow of refrigerant from said inner condenser to said outside heat exchanger;
(vi) an inside heat exchanger fluidly connectable to said refrigerant downstream of said inner condenser for selectively providing heating to a flow of cabin air;
(vii) a chiller fluidly connectable to said refrigerant downstream of said inner condenser for selectively heating a flow of liquid coolant;
(viii) a bypass channel system connected upstream of said first OCE and downstream of said outside heat exchanger for selectively routing said refrigerant from said inner condenser and/or from said outside heat exchanger (1) around said first expansion device and to either (A) a second OCE fluidly connected to said inside heat exchanger for selectively (a) providing in an expansion mode a flow of reduced pressure liquid refrigerant from said inner condenser to said inside heat exchanger; (b) allowing in an open mode said condensed high pressure refrigerant from said condenser or from said outside heat exchanger to pass without pressure reduction to said inside heat exchanger; or (c) preventing in a closed mode the flow of refrigerant to said inside heat exchanger; and/or (B) an expansion device fluidly connected to said chiller for selectively (a) providing in an expansion mode a flow of reduced pressure liquid refrigerant to said chiller; or (b) preventing in a closed mode the flow of refrigerant to said chiller; or (2) through said first OCE operating in the expansion mode through said outside heat exchanger; and
b) a heat exchange network interconnected with said vapor compression refrigeration circuit to selectively; (i) deliver, directly or indirectly, at said outside heat exchanger and/or at said chiller evaporative heat from one or more of ambient air and/or heat associated with the generation or use of electrical power within the vehicle and/or at said inside heat exchanger either directly or indirectly from (1) ambient air and/or (2) said electrical power source located in said vehicle.

2. The system of claim 1 further comprising a refrigerant accumulator, wherein said compressor is being connected upstream to said refrigerant accumulator.

3. The system of claim 1 wherein said refrigerant comprises R479A.

4. The system of claim 1 wherein said refrigerant consists essentially of R479A.

5. The system of claim 1 wherein said refrigerant consists of R479A.

6. The system of claim 1 wherein the heat exchange network comprises a coolant circuit that comprises a coolant that absorbs waste heat from an electrical power source located in said vehicle during low temperature ambient conditions and rejects heat to said refrigerant in said chiller.

7. A mobile vehicle having one or more electric traction motors and one or more batteries and/or capacitors providing electric current to said one or more traction motors comprising a heat transfer system carried by said mobile vehicle to alternatively and/or simultaneously provide heating and cooling in said mobile vehicle, wherein heating and/or cooling is provided to said one or more batteries and/or capacitors during charging and/or operation and that includes a cabin that requires heat input during low temperature ambient conditions, wherein said heat transfer system comprises:
a) a vapor compression refrigeration circuit located in said mobile vehicle comprising:
(i) a first refrigerant comprising from about 48% to about 52% by weight of 2,3,3,3-tetrafluoropropene (R1234yf), from about 20% to about 23% by weight of R32 and from about 26% to about 30% of R1132(E),
(ii) a compressor for compressing said first refrigerant in the vapor state from a first pressure to a higher second pressure, said compressor being connected upstream to a refrigerant accumulator,
(iii) an inner condenser for selectively condensing during low temperature ambient conditions at least a portion of said first refrigerant vapor from said compressor by rejecting heat to said cabin,
(iv) an outside heat exchanger located downstream of said inner condenser to selectively either (1) condense during low temperature ambient conditions at least a portion of said higher pressure refrigerant vapor not condensed in said inner condenser by rejecting heat, directly or indirectly, to ambient air and/or to a circulating coolant or (2) evaporate during high temperature ambient conditions low pressure refrigerant liquid from said inner condenser vapor;
(v) a first open/closed/expansion device connected between said inner condenser and said outside heat exchanger for selectively (1) providing in an expansion mode a flow of reduced pressure liquid refrigerant from said inner condenser to said outside heat exchanger; (2) allowing in an open mode said condensed high pressure refrigerant from said condenser to pass to said outside condenser without pressure drop to said outside heat exchanger; or (3) preventing in a closed mode the flow of refrigerant from said inner condenser to said outside heat exchanger;
(vi) an inside heat exchanger fluidly connectable to said refrigerant downstream of said inner condenser for selectively providing heating to a flow of cabin air;
(vii) a chiller fluidly connectable to said refrigerant downstream of said inner condenser for selectively heating a flow of liquid coolant;
(viii) a bypass channel system connected upstream of said first open/closed/expansion device and downstream of said outside heat exchanger for selectively routing said refrigerant from said inner condenser and/or from said outside heat exchanger (1) around said first expansion device and to either (A) a second open/closed/expansion device fluidly connected to said inside heat exchanger for selectively (a) providing in an expansion mode a flow of reduced pressure liquid refrigerant from said inner condenser to said inside heat exchanger; (b) allowing in an open mode said condensed high pressure refrigerant from said condenser or from said outside heat exchanger to pass without pressure reduction to said inside heat exchanger; or (c) preventing in a closed mode the flow of refrigerant to said inside heat exchanger; and/or (B) an expansion device fluidly connected to said chiller for selectively (a) providing in an expansion mode a flow of reduced pressure liquid refrigerant to said chiller; or (b) preventing in a closed mode the flow of refrigerant to said chiller; or (2) through said first open/closed/expansion device operating in the expansion mode through said outside heat exchanger to said accumulator; and
b) a heat exchange network interconnected with said vapor compression refrigeration circuit to selectively; (i) deliver, directly or indirectly, at said outside heat exchanger and/or at said chiller evaporative heat from one or more of ambient air and/or heat associated with the generation or use of electrical power within the vehicle and/or at said inside heat exchanger either directly or indirectly from (1) ambient air and/or (2) said electrical power source located in said vehicle.

8. The system of claim 6 wherein said refrigerant comprises R479A.

9. The system of claim 6 wherein said refrigerant consists essentially of R479A.

10. The system of claim 6 wherein said refrigerant consists of R479A.

11. The system of claim 6 wherein the heat exchange network comprises a coolant circuit that comprises a coolant that absorbs waste heat from an electrical power source located in said vehicle during low temperature ambient conditions and rejects heat to said refrigerant in said chiller.

12. A mobile vehicle having one or more electric traction motors and one or more batteries and/or capacitors providing electric current to said one or more traction motors comprising a heat transfer system carried by said mobile vehicle to alternatively and/or simultaneously provide heating and cooling in said mobile vehicle, wherein heating and/or cooling is provided to said one or more batteries and/or capacitors during charging and/or operation and that includes a cabin that requires heat input during low temperature ambient conditions, wherein said heat transfer system comprises:
a) a vapor compression refrigeration circuit located in said mobile vehicle comprising:
(i) a first refrigerant comprising a first refrigerant comprising from about 48% to about 52% by weight of 2,3,3,3-tetrafluoropropene (R1234yf), from about 20% to about 23% by weight of R32 and from about 26% to about 30% of R1132(E),
(ii) a compressor for compressing said first refrigerant in the vapor state from a first pressure to a higher second pressure, said compressor being connected upstream to a refrigerant accumulator,
(iii) an inner condenser for selectively condensing during low temperature ambient conditions at least a portion of said first refrigerant vapor from said compressor by rejecting heat to said cabin,
(iv) an outside heat exchanger located downstream of said inner condenser to selectively either (1) condense during low temperature ambient conditions at least a portion of said higher pressure refrigerant vapor not condensed in said inner condenser by rejecting heat, directly or indirectly, to ambient air and/or to a circulating coolant or (2) evaporate during high temperature ambient conditions low pressure refrigerant liquid from said inner condenser vapor;
(v) a first open/closed/expansion device connected between said inner condenser and said outside heat exchanger for selectively (1) providing in an expansion mode a flow of reduced pressure liquid refrigerant from said inner condenser to said outside heat exchanger; (2) allowing in an open mode said condensed high pressure refrigerant from said condenser to pass to said outside condenser without pressure drop to said outside heat exchanger; or (3) preventing in a closed mode the flow of refrigerant from said inner condenser to said outside heat exchanger;
(vi) an inside heat exchanger fluidly connectable to said refrigerant downstream of said inner condenser for selectively providing heating to a flow of cabin air;
(vii) a chiller fluidly connectable to said refrigerant downstream of said inner condenser for selectively heating a flow of liquid coolant;
(viii) a bypass channel system connected upstream of said first open/closed/expansion device and downstream of said outside heat exchanger for selectively routing said refrigerant from said inner condenser and/or from said outside heat exchanger (1) around said first expansion device and to either (A) a second open/closed/expansion device fluidly connected to said inside heat exchanger for selectively (a) providing in an expansion mode a flow of reduced pressure liquid refrigerant from said inner condenser to said inside heat exchanger; (b) allowing in an open mode said condensed high pressure refrigerant from said condenser or from said outside heat exchanger to pass without pressure reduction to said inside heat exchanger; or (c) preventing in a closed mode the flow of refrigerant to said inside heat exchanger; and/or (B) an expansion device fluidly connected to said chiller for selectively (a) providing in an expansion mode a flow of reduced pressure liquid refrigerant to said chiller; or (b) preventing in a closed mode the flow of refrigerant to said chiller; or (2) through said first open/closed/expansion device operating in the expansion mode through said outside heat exchanger to said accumulator; and
b) a heat exchange network interconnected with said vapor compression refrigeration circuit to selectively; (i) deliver, directly or indirectly, at said outside heat exchanger and/or at said chiller evaporative heat from one or more of ambient air and/or heat associated with the generation or use of electrical power within the vehicle and/or at said inside heat exchanger either directly or indirectly from (1) ambient air and/or (2) said electrical power source located in said vehicle.

13. The mobile vehicle of claim 12 wherein the heat exchange network comprises a coolant circuit that comprises a coolant that absorbs waste heat from an electrical power source located in said vehicle during low temperature ambient conditions and rejects heat to said refrigerant in said chiller.
